(19) United States
(12) Patent Application Publication
(10) Pub. No.: US 2024/0380847 A1
(43) Pub. Date: Nov. 14, 2024

(54) INFRINGEMENT HANDLING FOR BACKGROUND DATA TRANSFER (BDT) POLICY

(71) Applicant: Telefonaktiebolaget LM Ericsson (publ), Stockholm (SE)

(72) Inventors: Fengpei Zhang, Guangzhou (CN); Antonio Iniesta Gonzalez, Madrid (ES); Yun Zhang, Guangdong (CN); Jingrui Tao, Guangdong (CN)

(21) Appl. No.: 18/681,692

(22) PCT Filed: Jul. 29, 2022
(86) PCT No.: PCT/CN2022/108795

§ 371 Date: Feb. 6, 2024

(30) Foreign Application Priority Data
Aug. 11, 2021 (WO) PCT/CN2021/112070

(51) Int. Cl. H04M 15/00; H04L 12/14

(52) U.S. Cl. CPC H04M 15/66; H04L 12/1407; H04M 15/8088

(57) ABSTRACT

The present disclosure is related to methods and network nodes for handling infringement of a background data transfer (BDT) policy. A method at a first network node for handling infringement of one or more conditions associated with a negotiated BDT policy, the method comprising: determining whether a user equipment (UE) infringes any of the one or more conditions other than one or more negotiated time intervals during which BDT is expected to be performed by the UE; and triggering updating of a charging rate applied for the UE in response to determining that the UE infringes at least one of the one or more conditions.

### CROSS-REFERENCE TO RELATED APPLICATION(S)

This application claims priority to the PCT International Application No. PCT/CN2021/112070, entitled “INFRINGEMENT HANDLING FOR BACKGROUND DATA TRANSFER (BDT) POLICY”, filed on Aug. 11, 2021, which is incorporated herein by reference in its entirety.

### TECHNICAL FIELD

The present disclosure is related to the field of telecommunications, and in particular, to methods and network nodes for handling infringement of a background data transfer (BDT) policy.

### BACKGROUND

A Service Capability Exposure Function (SCEF) or an equivalent functional entity in 5G Core called Network Exposure Function (NEF) is a key function in the 3GPP architecture for service capability exposure that provides a means to securely expose services and capabilities provided by Third Generation Partnership Project (3GPP) network interfaces to Application Servers (ASs)/Service Capability Servers (SCSs)/Application Functions (AFs) through Application Programming Interfaces (APIs). The SCEF/NEF has defined a mechanism called BDT that allows the ASs/SCSs/AFs to initiate a background transfer for non-time-critical data, for example, firmware updating data, log data, and sensor data, etc., to one or more User Equipments (UEs) located in a specific geographical area. Such non-time-critical data transfer may happen at off peak periods of 3GPP network (for example, at night), and correspondingly a reduced charging rate (e.g., a certain percentage of a normal charging rate, such as 50%) may be applied to the one or more UEs when performing BDT.

The BDT consists of 2 procedures:
a BDT policy negotiation procedure for negotiating a BDT policy to be applied to the one or more UEs;
a BDT policy activation procedure for activating the negotiated BDT policy such that it can be applied to the one or more UEs when performing BDT.

The negotiated BDT policy is associated with the reduced charging rate, and also one or more conditions, such as one or more negotiated time intervals during which BDT is expected to be performed by the UE. For any of the one or more UEs that satisfies all of the one or more conditions, the reduced charging rate negotiated during the BDT policy negotiation procedure may be applied to it when performing BDT according to the negotiated BDT policy.

### SUMMARY

According to a first aspect of the present disclosure, a method at a first network node for handling infringement of one or more conditions associated with a negotiated BDT policy is provided. The method includes determining whether a UE infringes any of the one or more conditions other than one or more negotiated time intervals during which BDT is expected to be performed by the UE. The method further includes triggering updating of a charging rate applied for the UE in response to determining that the UE infringes at least one of the one or more conditions.

In some embodiments, the step of triggering updating of the charging rate applied for the UE may include triggering applying a charging rate for the UE that is different from a negotiated charging rate associated with the BDT policy in response to determining that the UE infringes the at least one condition.

In some embodiments, the one or more conditions may include at least one of: a negotiated number of UEs expected to participate in data transfer associated with the BDT policy and a total data volume associated with the BDT policy.

In some embodiments, the method may further include transmitting, to a second network node, a first message for notifying that the at least one condition is infringed in response to determining that the UE infringes the at least one condition.

In some embodiments, the step of triggering updating of a charging rate applied for the UE may include transmitting, to a third network node, a second message indicating the infringement of the at least one condition by the UE when the at least one condition includes the negotiated number of UEs and/or the total data volume.

In some embodiments, the step of determining whether the UE infringes any of the one or more conditions may include determining whether an index of the UE in a UE list is greater than the negotiated number of UEs or not, the UE list comprising all UEs that participate in BDT sessions and the UEs in the UE list being indexed in a chronological order of their corresponding BDT sessions. In some embodiments, the step of determining whether the UE infringes any of the one or more conditions may further include determining that the UE infringes the at least one condition in response to determining that the index of the UE in the UE list is greater than the negotiated number of UEs.

In some embodiments, before the step of determining whether the UE infringes any of the one or more conditions, the method may further include receiving, from the second network node, a fourth message for activating a BDT session for the UE. Further, the method further includes determining an identifier of the UE from the fourth message. In some embodiments, before the step of determining whether the UE infringes any of the one or more conditions, the method may further include adding the identifier of the UE into the UE list in response to determining that the UE is not in the UE list at least partially based on the identifier of the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the fourth message may include a reference ID identifying the BDT policy. In some embodiments, before the step of adding the identifier of the UE into the UE list, the method further may include retrieving the UE list by using the reference ID.

In some embodiments, after the step receiving, from the second network node, a fourth message for activating a BDT session for the UE, the method may include authenticating the fourth message to verify if the second network node is allowed to activate the BDT session for the UE or not.

In some embodiments, the first message may be a response message corresponding to the fourth message.

In some embodiments, the first message may be another message that is transmitted separately from the response message corresponding to the fourth message.

In some embodiments, the step of determining whether the UE infringes any of the one or more conditions may include determining whether the total data volume is consumed or not. In some embodiments, the step of determining whether the UE infringes any of the one or more conditions may further include determining that the UE infringes the at least one condition in response to determining that the total data volume is consumed.

In some embodiments, before the step of determining whether the total data volume is consumed or not, the method may include receiving, from the second network node, a fourth message for activating a BDT session for the UE. In some embodiments, before the step of determining whether the total data volume is consumed or not, the method may include determining a current available data volume associated with the BDT policy that is indicated by a reference ID comprised in the fourth message. In some embodiments, the current available data volume may have an initial value equal to the total data volume, and its value may be reduced whenever a volume slice is allocated for a BDT session for a UE associated with the BDT policy.

In some embodiments, the step of determining whether the total data volume is consumed or not may include determining that the total data volume is consumed in response to determining that the current available data volume is not greater than zero. In some embodiments, the step of determining whether the total data volume is consumed or not may further include determining that the total data volume is not consumed in response to determining that the current available data volume is greater than zero.

In some embodiments, the method may further include deducting, from the current available data volume, a volume of a volume slice that is allocated to the BDT session in response to determining that the total data volume is not consumed. In some embodiments, the method may further include determining an IP address of the UE from the fourth message. In some embodiments, the method may further include determining an identifier of the UE based on its IP address by looking up the IP address in a table that maps the IP address to the identifier, the table being maintained at the first network node. In some embodiments, the method may further include transmitting, to the third network node, a second subscription request for subscribing notification of an event that the volume slice is consumed by the BDT session.

In some embodiments, the method may further include receiving, from the third network node, a fifth message for notifying the event that the volume slice allocated to the BDT session is consumed. In some embodiments, the method may further include determining whether the current available data volume is greater than zero or not. In some embodiments, the method may further include deducting, from the current available data volume, a volume of another volume slice that is allocated to the BDT session in response to determining that the current available data volume is greater than zero. In some embodiments, the method may further include transmitting, to the third network node, another second subscription request for subscribing notification of an event that the other volume slice is consumed by the BDT session.

In some embodiments, the method may further include receiving, from the third network node, a fifth message for notifying the event that the volume slice allocated to the BDT session is consumed. In some embodiments, the method may further include determining whether the current available data volume is greater than zero or not. In some embodiments, the method may further include determining that the total data volume is consumed in response to determining that the current available data volume is not greater than zero.

In some embodiments, the method may further include transmitting, to the second network node, the first message for notifying that the at least one condition is infringed by the UE when the at least one condition includes the total data volume. In some embodiments, the method may further include determining all BDT sessions associated with the BDT policy in response to determining that the total data volume is consumed. In some embodiments, the method may further include, for each of the BDT sessions, transmitting, to the third network node, the second message indicating the infringement of the at least one condition to trigger updating of a charging rate applied for the corresponding BDT session.

In some embodiments, before the step of determining whether a UE infringes any of the one or more conditions, the method may further include receiving, from the second network node, a sixth message indicating that a notification of infringement of the BDT policy is enabled. In some embodiments, before the step of determining whether a UE infringes any of the one or more conditions, the method may further include creating a BDT session object for the BDT policy. In some embodiments, the BDT session object may include at least one of: a reference ID identifying the BDT policy, information of the BDT policy, a list of UEs that participate in data transfer associated with the BDT policy, and a current available data volume associated with the BDT policy.

In some embodiments, the first network node may be a Service Capability Exposure Function (SCEF) or a Network Exposure Function (NEF). In some embodiments, the second network node may be an Application Server (AS), a Service Capability Server (SCS), or an Application Function (AF). In some embodiments, the third network node may be a Policy and Charging Rule Function (PCRF) or a Policy Control Function (PCF).

According to a second aspect of the present disclosure, a method at a first network node for handling infringement of one or more conditions associated with a negotiated BDT policy is provided. The method includes determining whether a UE infringes any of the one or more conditions other than one or more negotiated time intervals during which BDT is expected to be performed by the UE. The method further includes in response to determining that the UE infringes at least one of the one or more conditions, transmitting, to a second network node, a first message for notifying that the at least one condition is infringed.

In some embodiments, the one or more conditions may include at least one of: a negotiated number of UEs expected to participate in data transfer associated with the BDT policy, a negotiated geographic area in which data transfer associated with the BDT policy is expected to be conducted, and a total data volume associated with the BDT policy.

In some embodiments, the method may further include triggering updating of a charging rate applied for the UE in response to determining that the UE infringes the at least one condition.

In some embodiments, the step of triggering updating of the charging rate applied for the UE in response to determining that the UE infringes the at least one condition may include triggering applying a charging rate for the UE that is different from a negotiated charging rate associated with the BDT policy in response to determining that the UE infringes the at least one condition.

In some embodiments, the step of triggering updating of a charging rate applied for the UE may include transmitting, to a third network node, a second message indicating the infringement of the at least one condition by the UE when the at least one condition includes the negotiated number of UEs and/or the total data volume.

In some embodiments, the step of determining whether the UE infringes any of the one or more conditions may include determining whether an index of the UE in a UE list is greater than the negotiated number of UEs or not, the UE list comprising all UEs that participate in BDT sessions and the UEs in the UE list being indexed in a chronological order of their corresponding BDT sessions. In some embodiments, the step of determining whether the UE infringes any of the one or more conditions may further include determining that the UE infringes the at least one condition in response to determining that the index of the UE in the UE list is greater than the negotiated number of UEs.

In some embodiments, before the step of determining whether the UE infringes any of the one or more conditions, the method may further include receiving, from the second network node, a fourth message for activating a BDT session for the UE. In some embodiments, before the step of determining whether the UE infringes any of the one or more conditions, the method may further include determining an identifier of the UE from the fourth message. In some embodiments, before the step of determining whether the UE infringes any of the one or more conditions, the method may further include adding the identifier of the UE into the UE list in response to determining that the UE is not in the UE list at least partially based on the identifier of the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the fourth message may include a reference ID identifying the BDT policy. In some embodiments, before the step of adding the identifier of the UE into the UE list, the method may further include retrieving the UE list by using the reference ID.

In some embodiments, after the step receiving, from the second network node, a fourth message for activating a BDT session for the UE, the method may include authenticating the fourth message to verify if the second network node is allowed to activate the BDT session for the UE or not.

In some embodiments, the first message may be a response message corresponding to the fourth message.

In some embodiments, the first message may be another message that is transmitted separately from the response message corresponding to the fourth message.

In some embodiments, the step of determining whether the UE infringes any of the one or more conditions may include receiving, from the third network node, a third message for notifying the first network node of an event that the UE exits from or enters into the negotiated geographic area. In some embodiments, the step of determining whether the UE infringes any of the one or more conditions may include determining that the UE infringes the at least one condition in response to the third message notifying an event that the UE exits from the negotiated geographic area.

In some embodiments, before the step of receiving, from the third network node, a third message, the method may further include receiving, from the second network node, a fourth message for activating a BDT session for the UE. In some embodiments, before the step of receiving, from the third network node, a third message, the method may further include determining an identifier of the UE from the fourth message. In some embodiments, before the step of receiving, from the third network node, a third message, the method may further include transmitting, to the third network node, a first subscription request for subscribing notification of the event for the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the first subscription request may include an indicator indicating the negotiated geographic area and the identifier of the UE.

In some embodiments, the first message may be another message that is transmitted separately from the response message corresponding to the fourth message.

In some embodiments, the step of determining whether the UE infringes any of the one or more conditions may include determining whether the total data volume is consumed or not. In some embodiments, the step of determining whether the UE infringes any of the one or more conditions may include determining that the UE infringes the at least one condition in response to determining that the total data volume is consumed.

In some embodiments, before the step of determining whether the total data volume is consumed or not, the method may include receiving, from the second network node, a fourth message for activating a BDT session for the UE. In some embodiments, before the step of determining whether the total data volume is consumed or not, the method may further include determining a current available data volume associated with the BDT policy that is indicated by a reference ID comprised in the fourth message. In some embodiments, the current available data volume may have an initial value equal to the total data volume, and its value may be reduced whenever a volume slice is allocated for a BDT session for a UE associated with the BDT policy.

In some embodiments, the step of determining whether the total data volume is consumed or not may include determining that the total data volume is consumed in response to determining that the current available data volume is not greater than zero. In some embodiments, the step of determining whether the total data volume is consumed or not may further include determining that the total data volume is not consumed in response to determining that the current available data volume is greater than zero.

In some embodiments, the method may further include deducting, from the current available data volume, a volume of a volume slice that is allocated to the BDT session in response to determining that the total data volume is not consumed. In some embodiments, the method may further include determining an IP address of the UE from the fourth message. In some embodiments, the method may further include determining an identifier of the UE based on its IP address by looking up the IP address in a table that maps the IP address to the identifier, the table being maintained at the first network node. In some embodiments, the method may further include transmitting, to the third network node, a second subscription request for subscribing notification of an event that the volume slice is consumed by the BDT session.

In some embodiments, the method may further include receiving, from the third network node, a fifth message for notifying the event that the volume slice allocated to the BDT session is consumed. In some embodiments, the method may further include determining whether the current available data volume is greater than zero or not. In some embodiments, the method may further include deducting, from the current available data volume, a volume of another volume slice that is allocated to the BDT session in response to determining that the current available data volume is greater than zero. In some embodiments, the method may further include transmitting, to the third network node, another second subscription request for subscribing notification of an event that the other volume slice is consumed by the BDT session.

In some embodiments, the method may further include receiving, from the third network node, a fifth message for notifying the event that the volume slice allocated to the BDT session is consumed. In some embodiments, the method may further include determining whether the current available data volume is greater than zero or not. In some embodiments, the method may further include determining that the total data volume is consumed in response to determining that the current available data volume is not greater than zero.

In some embodiments, the method may further include transmitting, to the second network node, the first message for notifying that the at least one condition is infringed by the UE when the at least one condition includes the total data volume. In some embodiments, the method may further include determining all BDT sessions associated with the BDT policy in response to determining that the total data volume is consumed. In some embodiments, the method may further include, for each of the BDT sessions, transmitting, to the third network node, the second message indicating the infringement of the at least one condition to trigger updating of a charging rate applied for the corresponding BDT session.

In some embodiments, before the step of determining whether a UE infringes any of the one or more conditions, the method may further include receiving, from the second network node, a sixth message indicating that a notification of infringement of the BDT policy is enabled. In some embodiments, before the step of determining whether a UE infringes any of the one or more conditions, the method may further include creating a BDT session object for the BDT policy. In some embodiments, the BDT session may include at least one of: a reference ID identifying the BDT policy, information of the BDT policy, a list of UEs that participate in data transfer associated with the BDT policy, and a current available data volume associated with the BDT policy.

In some embodiments, the first network node may be a SCEF or a NEF. In some embodiments, the second network node may be an AS, a SCS, or an AF. In some embodiments, the third network node may be a PCRF or a PCF.

According to a third aspect of the present disclosure, a first network node is provided. The first network node includes a processor. The first network node further includes a memory storing instructions which, when executed by the processor, cause the processor to perform the method of any of the first aspect and the second aspect.

According to a fourth aspect of the present disclosure, a method at a second network node for handling infringement of one or more conditions associated with a negotiated BDT policy is provided. The method includes transmitting, to a first network node, a fourth message for activating a BDT session for a UE. The method further includes receiving, from the first network node, a first message for notifying that at least one of the one or more conditions is infringed by the BDT session.

In some embodiments, the method may further include transmitting, to the first network node, a sixth message indicating that a notification of infringement of the BDT policy is enabled.

In some embodiments, the one or more conditions may include at least one of: a negotiated number of UEs expected to participate in data transfer associated with the BDT policy, a negotiated geographic area in which data transfer associated with the BDT policy is expected to be conducted, and a total data volume that is associated with the BDT policy.

In some embodiments, the fourth message may include an IP address of the UE.

In some embodiments, the fourth message may include a reference ID identifying the BDT policy.

In some embodiments, the first message may be a response message corresponding to the fourth message.

In some embodiments, the first message may be another message that is transmitted separately from the response message corresponding to the fourth message.

In some embodiments, the first network node may be a SCEF or a NEF. In some embodiments, the second network node may be an AS, a SCS, or an AF.

According to a fifth aspect of the present disclosure, a second network node is provided. The second network node includes a processor. The second network node further includes a memory storing instructions which, when executed by the processor, cause the processor to perform the method of the fourth aspect.

According to a sixth aspect of the present disclosure, a method at a third network node for handling infringement of one or more conditions associated with a negotiated BDT policy is provided. The method includes receiving, from a first network node, a request for determining whether a UE infringes any of the one or more conditions other than one or more negotiated time intervals during which BDT is expected to be performed by the UE. The method further includes determining whether the UE infringes any of the one or more conditions other than one or more negotiated time intervals during which BDT is expected to be performed by the UE. The method further includes triggering updating of a charging rate applied for the UE in response to determining that the UE infringes at least one of the one or more conditions.

In some embodiments, the one or more conditions may include a negotiated geographic area in which data transfer associated with the BDT policy is expected to be conducted.

In some embodiments, the method may further include transmitting, to the first network node, a message for notifying an event that the UE exits from or enters into the negotiated geographic area in response to detecting the event.

In some embodiments, when the request is a subscription request for subscribing notification of the event that the UE exits from or enters into the negotiated geographic area, the subscription request may include an indicator indicating the negotiated geographic area and the identifier of the UE.

In some embodiments, the step of detecting the event may include performing a procedure for locating the UE indicated by the identifier of the UE. In some embodiments, the step of detecting the event may further include checking whether the UE exits from or enters into the negotiated geographic area by comparing the location of the UE with the negotiated geographic area.

In some embodiments, the first network node may be a SCEF or a NEF. In some embodiments, the third network node may be a PCRF or a PCF.

According to a seventh aspect of the present disclosure, a method at a third network node for handling infringement of one or more conditions associated with a negotiated BDT policy is provided. The method includes receiving, from a first network node, a message indicating that at least one of the one or more conditions is infringed by a UE. The method further includes triggering updating of a charging rate applied for the UE in response to the received message.

In some embodiments, the one or more conditions may include at least one of: a negotiated number of UEs expected to participate in data transfer associated with the BDT policy, and a total data volume associated with the BDT policy.

In some embodiments, the step of triggering updating of a charging rate applied for the UE in response to the received message may include triggering applying a charging rate for the UE that is different from a negotiated charging rate associated with the BDT policy in response to the received message.

In some embodiments, the first network node may be a SCEF or a NEF. In some embodiments, the third network node may be a PCRF or a PCF.

According to an eighth aspect of the present disclosure, a method at a third network node for BDT management is provided. The method includes receiving, from a first network node, a subscription request for subscribing notification of an event that a UE exits from or enters into a negotiated geographic area and/or for subscribing notification of an event that a volume slice is consumed by the UE. The method further includes detecting at least one of the events. The method further includes transmitting, to the first network node, a message for notifying the event that the UE exits from or enters into the negotiated geographic area and/or for notifying the event that the volume slice is consumed by the UE in response to detecting the corresponding event.

In some embodiments, when the subscription request is subscribing notification of the event that the UE exits from or enters into the negotiated geographic area, the subscription request may include an indicator indicating the negotiated geographic area and the identifier of the UE.

In some embodiments, the step of detecting at least one of the events may include performing a procedure for locating the UE indicated by the identifier of the UE. In some embodiments, the step of detecting at least one of the events may further include checking whether the UE exits from or enters into the negotiated geographic area by comparing the location of the UE with the negotiated geographic area.

In some embodiments, when the subscription request is subscribing notification of the event that the volume slice is consumed by the UE, the method may further include transmitting, to a fourth network node, a seventh message for subscribing an event that the volume slice is consumed by the UE.

In some embodiments, the method may further include receiving, from the fourth network node, an eighth message for notifying the event.

In some embodiments, the first network node may be a SCEF or a NEF. In some embodiments, the third network node may be a PCRF or a PCF. In some embodiments, the fourth network node may be a Policy & Charging Enforcement Function (PCEF) or a User Plane Function (UPF).

According to a ninth aspect of the present disclosure, a third network node is provided. The third network node includes a processor. The third network node further includes a memory storing instructions which, when executed by the processor, cause the processor to perform the method of any of the sixth aspect, the seventh aspect, and the eighth aspect.

According to a tenth aspect of the present disclosure, a computer program comprising instructions is provided, The instructions when executed by at least one processor, cause the at least one processor to carry out the method of any of the first aspect, the second aspect, the fourth aspect, the sixth aspect, the seventh aspect, and the eighth aspect.

According to an eleventh aspect of the present disclosure, a carrier containing the computer program of the tenth aspect is provided. The carrier may be one of an electronic signal, optical signal, radio signal, or computer readable storage medium.

According to a twelfth aspect of the present disclosure, a telecommunications system is provided. The telecommunications system includes a first network node of the third aspect. The telecommunications system further includes a second network node of the fifth aspect. The telecommunications system further includes a third network node of the ninth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary architecture for 5G network in which handling infringement of one or more conditions associated with a negotiated BDT policy according to an embodiment of the present disclosure may be applicable.

FIG. 2 is a diagram illustrating an exemplary BDT policy negotiation procedure in which handling infringement of one or more conditions associated with a negotiated BDT policy according to an embodiment of the present disclosure may be applicable.

FIG. 3 is a diagram illustrating an exemplary BDT policy activation procedure in which handling infringement of one or more conditions associated with a negotiated BDT policy according to an embodiment of the present disclosure may be applicable.

FIG. 4 is a diagram illustrating an exemplary scenario in which handling infringement of one or more conditions associated with a negotiated BDT policy according to an embodiment of the present disclosure may be applicable.

FIG. 5 is a diagram illustrating an exemplary BDT policy negotiation procedure for handling infringement of one or more conditions associated with a negotiated BDT policy according to an embodiment of the present disclosure.

FIG. 6 is a diagram illustrating an exemplary procedure for a UE to attach to a network node in which handling infringement of one or more conditions associated with a negotiated BDT policy according to an embodiment of the present disclosure may be applicable.

FIG. 7 is a diagram illustrating an exemplary procedure for handling infringement of a negotiated number of UEs associated with a negotiated BDT policy according to an embodiment of the present disclosure.

FIG. 8 is a diagram illustrating another exemplary procedure for handling infringement of a negotiated number of UEs associated with a negotiated BDT policy according to another embodiment of the present disclosure.

FIG. 9 is a diagram illustrating an exemplary procedure for handling infringement of a negotiated geographic area associated with a negotiated BDT policy according to an embodiment of the present disclosure.

FIG. 10A and FIG. 10B are diagrams illustrating an exemplary procedure for handling infringement of a negotiated total data volume associated with a negotiated BDT policy according to an embodiment of the present disclosure.

FIG. 11 is a flow chart of an exemplary method at a first network node for handling infringement of one or more conditions associated with a negotiated BDT policy according to an embodiment of the present disclosure;

FIG. 12 is a flow chart of another exemplary method at a first network node for handling infringement of one or more conditions associated with a negotiated BDT policy according to another embodiment of the present disclosure.

FIG. 13 is a flow chart of an exemplary method at a second network node handling infringement of one or more conditions associated with a negotiated BDT policy according to an embodiment of the present disclosure.

FIG. 14 is a flow chart of an exemplary method at a third network node handling infringement of one or more conditions associated with a negotiated BDT policy according to an embodiment of the present disclosure.

FIG. 15 is a flow chart of an exemplary method at a third network node handling infringement of one or more conditions associated with a negotiated BDT policy according to another embodiment of the present disclosure.

FIG. 16 is a flow chart of an exemplary method at a third network node handling infringement of one or more conditions associated with a negotiated BDT policy according to yet another embodiment of the present disclosure.

FIG. 17 schematically shows an embodiment of an arrangement which may be used in a first, second, and/or third network node according to an embodiment of the present disclosure.

FIG. 18 is a diagram illustrating an exemplary scenario in which infringement of one or more conditions associated with a negotiated BDT policy is handled according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as handling infringement of BDT policies is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, or any other equivalents. Further, the term “node” used herein may refer to a UE, a functional entity, a network entity, a network element, a network equipment, or any other equivalents.

The following 3GPP documents are incorporated herein by reference in their entireties:
3GPP TS 23.682 V16.6.0 (2020-03), 3rd Generation Partnership Project; Technical Specification Group Services and System Aspects; Architecture enhancements to facilitate communications with packet data networks and applications (Release 16);
3GPP TS 29.122 V16.5.0 (2020-03), 3rd Generation Partnership Project; Technical Specification Group Core Network and Terminals; T8 reference point for Northbound APIs; (Release 16); and
3GPP TS 29.522 V16.3.0 (2020-03), 3rd Generation Partnership Project; Technical Specification Group Core Network and Terminals; 5G System; Network Exposure Function Northbound APIs; Stage 3 (Release 16).

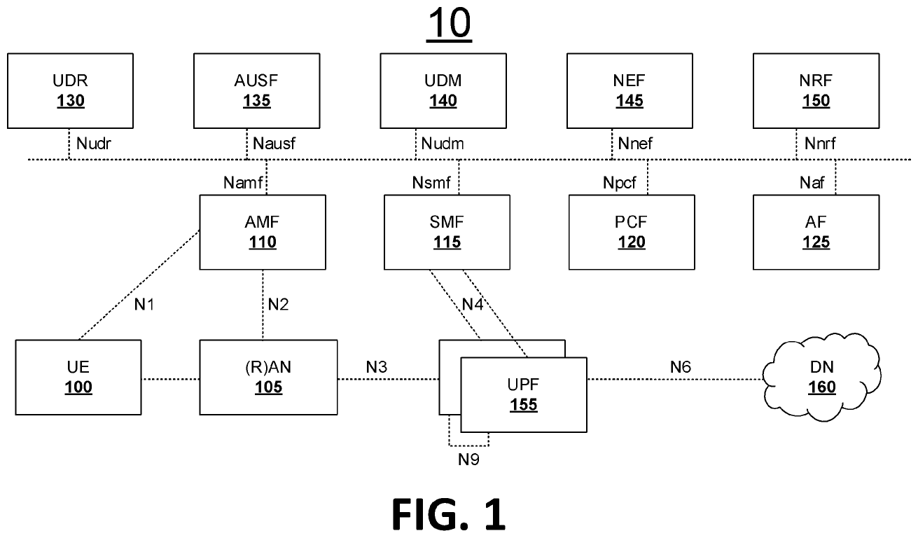

FIG. 1 is a diagram illustrating an exemplary architecture 10 for 5G network in which handling infringement of one or more conditions associated with a negotiated BDT policy according to an embodiment of the present disclosure may be applicable. As shown in FIG. 1, the network 10 may comprise one or more UEs 100 and a (radio) access network ((R)AN) 105, which could be a base station, a Node B, an evolved NodeB (eNB), a gNB, or any entity which provides the UEs 100 with access to the network 10. Further, the network 10 may comprise its core network portion comprising (but not limited to) an Access and Mobility Management Function (AMF) 110, a Session Management Function (SMF) 115, a PCF 120, an AF 125, a Unified Data Repository (UDR) 130, an Authentication Server Function (AUSF) 135, a Unified Data Management (UDM) 140, an NEF 145, a Network Repository Function (NRF) 150, and one or more UPFs 155. As shown in FIG. 1, these entities may communicate with each other via the service-based interfaces, such as, Namf, Nsmf, Npcf, etc. and/or the reference points, such as, N1, N2, N3, N6, N9, etc.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. Therefore, it is to be noted that, in the present disclosure, some procedures are described for an Evolved Packet Core (EPC) network, but there are similar procedures defined also for the 5G core network, mainly just replacing:
PCRF by PCF;
Subscription Profile Repository (SPR) by UDR;
SCS/AS by AF;
SCEF by NEF;
Packet Data Network (PDN) Gateway for Control Plane (PGW-C) or Traffic Detection Function for Control Plane (TDF-C) by Session Management Function (SMF);
Packet Data Network (PDN) Gateway for User Plane (PGW-U) or Traffic Detection Function for User Plane (TDF-U) by UPF.

For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

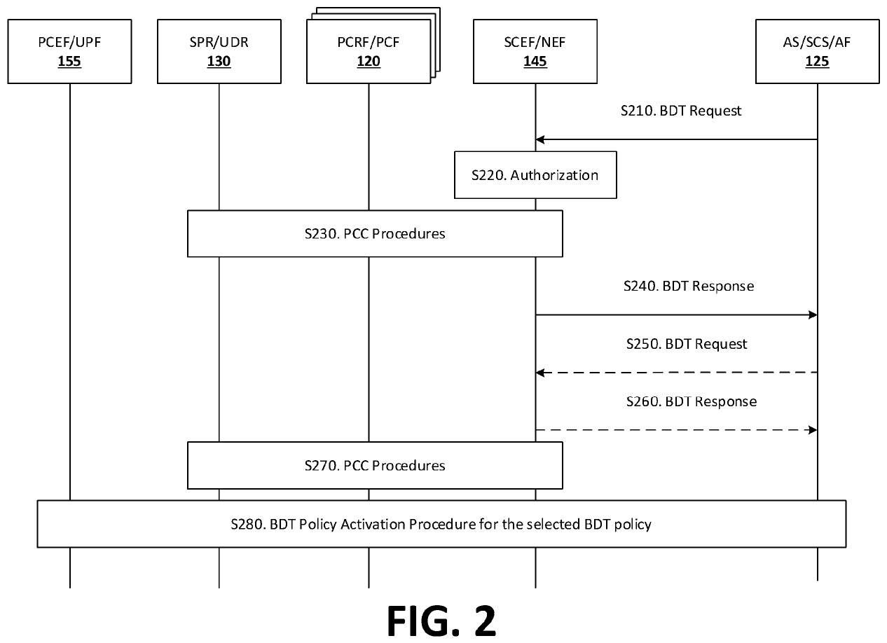

FIG. 2 is a diagram illustrating an exemplary BDT policy negotiation procedure in which handling infringement of one or more conditions associated with a negotiated BDT policy according to an embodiment of the present disclosure may be applicable.

As shown in FIG. 2, an AS/SCS/AF 125 tries to negotiate a BDT policy for a UE with a network (e.g., the network 10 shown in FIG. 1), which includes a PCEF/UPF 155, an SPR/UDR 130, a PCRF/PCF 120, and an SCEF/NEF 145, and the description of the steps of the procedure is given below. In some embodiments, the AS/SCS/AF 125 may be a manufacturer/operator/provider of the UE. As an example, the UE may be a vehicle, and the AS/SCS/AF 125 may be its manufacturer or a connected vehicle platform (CVP).

Step S210. The AS/SCS/AF 125 transmits a BDT request to the SCEF/NEF 145 to initiate a procedure for negotiation a BDT policy for one or more UEs. In some embodiments, the BDT request may include one or more of an identifier of the AS/SCS/AF 125, Volume per UE, Number of UEs, and Desired Time Window. The Volume per UE defines the data volume the AS/SCS/AF 125 expects to be transferred per UE during the BDT. The Number of UEs defines the number of UEs expected to participate in the BDT. The Desired Time Window defines the time interval during which the AS/SCS/AF 125 desires to realize the BDT. Optionally, the AS/SCS/AF 125 can provide geographic area information. As an example, the BDT request may also include a geographic area in which the BDT is expected to be conducted.

Step S220. The SCEF/NEF 145 authorizes the BDT request transmitted from the AS/SCS/AF 125.

Step S230. One or more policy and charging control (PCC) procedures are performed at the SPR/UDR 130, PCRF/PCF 120, and SCEF/NEF 145, for example, as defined in 3GPP TS 23.203. For example, the SCEF/NEF 145 selects an available PCRF/PCF 120 and triggers to further negotiate the BDT policy with the selected PCRF/PCF 120. For example, the SCEF/NEF 145 forwards the parameters contained in the BDT request to the PCRF/PCF 120. The PCRF/PCF 120 responds to the SCEF/NEF 145 with one or more possible BDT policies and reference IDs identifying these BDT policies.

Step S240. The SCEF/NEF 145 transmits a BDT response to the AS/SCS/AF 125. The BDT response includes the received reference IDs identifying the BDT policies and the corresponding BDT policies. The AS/SCS/AF 125 stores the reference IDs and the corresponding BDT policies for the future interaction with the PCRF/PCF 120.

Step S250. The AS/SCS/AF 125 selects one of BDT policies when more than one reference IDs are received and transmits another BDT request to the SCEF/NEF 145 so as to inform the SCEF/NEF 145 and PCRF/PCF 120 about the selected BDT policy. Here, the BDT request contains the identifier of the AS/SCS/AF 125, the reference ID identifying the selected BDT policy, and the selected BDT policy itself.

Step S260. The SCEF/NEF 145 transmits a BDT response to the AS/SCS/AF 125 so as to confirm the BDT policy selection.

Step S270. One or more PCC procedures are performed at the SPR/UDR 130, PCRF/PCF 120, and SCEF/NEF 145. For example, the SCEF/NEF 145 continues the BDT policy negotiation procedure with the PCRF/PCF 120. The PCRF/PCF 120 stores the reference ID identifying the selected BDT policy and the selected BDT policy itself in the SPR/UDR 130.

Step S280. A BDT policy activation procedure for the selected BDT policy is performed at the PCEF/UPF 155, SPR/UDR 130, PCRF/PCF 120, SCEF/NEF 145 and AS/SCS/AF 125. For example, the AS/SCS/AF 125 contacts the PCRF/PCF 120 or a different PCRF/PCF for each UE, e.g., via an Rx interface, and provides the reference ID identifying the selected BDT policy thereto. Alternatively, the AS/SCS/AF 125 activates the selected BDT policy for each UE via the SCEF/NEF 145 by using the “Set the chargeable party at session set-up” and/or “Change the chargeable party during the session” procedure to provide the reference ID to the PCRF/PCF 120 or a different PCRF/PCF. The PCRF/PCF 120 or the different PCRF/PCF correlates a request to activate the selected BDT policy from the AS/SCS/AF 125 or SCEF/NEF 145 with the BDT policy retrieved from the SPR/UDR 130 via the reference ID identifying the selected BDT policy. The PCRF/PCF 120 finally triggers PCC procedures so as to provide information about the selected BDT policy to the PCEF/UPF 155 for BDT of the UE.

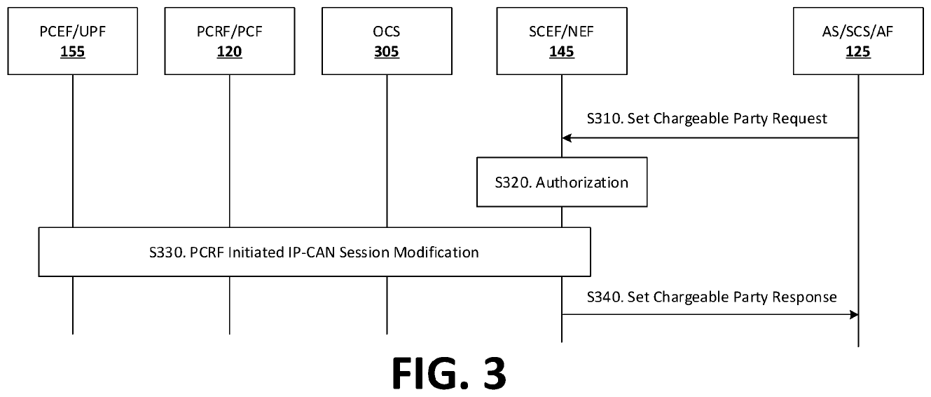

With the procedure shown in FIG. 2, a BDT policy may be negotiated between the AS/SCS/AF 125 and the network. Then, the AS/SCS/AF 125 may request to activate the negotiated BDT policy when a UE connects with it, for example, as shown in FIG. 3.

FIG. 3 is a diagram illustrating an exemplary BDT policy activation procedure in which handling infringement of one or more conditions associated with a negotiated BDT policy according to an embodiment of the present disclosure may be applicable.

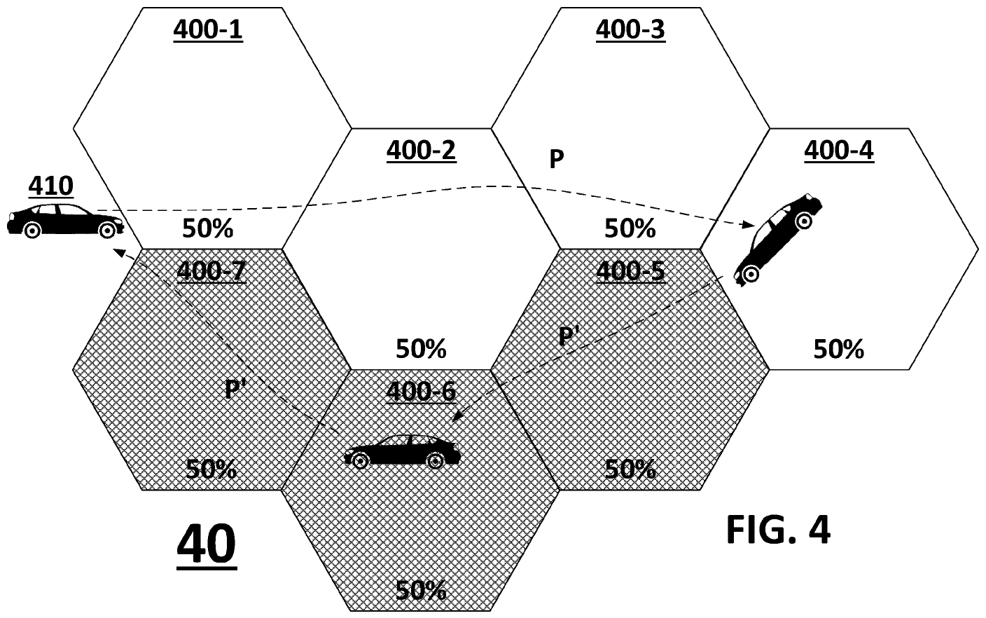

Step S310. When a UE (e.g., a vehicle 410 shown in FIG. 4) wants to conduct a BDT transmission, it may connect to the AS/SCS/AF 125 (e.g., the CVP), and then the AS/SCS/AF 125 requests to become a chargeable party for a session to be set up between the UE and a network by transmitting a Set chargeable party request to the SCEF/NEF 145. The request may contain at least one of the identifier of the AS/SCS/AF 125, description of application flows, and the reference ID identifying the selected BDT policy. Optionally, the request may further contain sponsor information, for example, Sponsoring Status and a usage threshold. The Sponsoring Status indicates whether sponsoring is started or stopped, i.e., whether the AS/SCS/AF 125 is a chargeable party or not. The SCEF/NEF 145 assigns a T8 Long Term Transaction Reference ID (TLTRI) to the Set chargeable party request at step S310.

Step S320. The SCEF/NEF 145 authorizes the request of the AS/SCS/AF 125 to sponsor application traffic for the UE and stores the sponsor information together with the identifier of the AS/SCS/AF 125 and the TLTRI. If the authorization fails, S330 is skipped and the SCEF/NEF 145 replies to the AS/SCS/AF 125 with a Result value indicating that the authorization failed.

Step S330. The SCEF/NEF 145 interacts with the PCRF/PCF 120, for example, by triggering a PCRF initiated IP-Connectivity Access Network (IP-CAN) Session Modification as described in clause 7.4.2 of 3GPP TS 23.203 and provides at least one of IP filter information, the reference ID identifying the selected BDT policy, sponsored data connectivity information (if received from the AS/SCS/AF 125) and the Sponsoring Status (if received from the AS/SCS/AF 125) to the PCRF/PCF 120. In some embodiments, the SCEF/NEF 145 interacts with PCRF/PCF 120 via a Diameter Rx interface as described in 3GPP TS 29.214.

Step S340. The SCEF/NEF 145 transmits a Set Chargeable Party response, which may contain the TLTRI and a Result value, to the AS/SCS/AF 125. The Result value indicates whether the authentication succeeds or not. In the case where the Result value indicates that the authentication succeeds, the negotiated BDT policy is successfully activated.

The above BDT policy activation procedure shown in FIG. 3 can allow the AS/SCS/AF 125 not only to request to sponsor the traffic from the beginning but also to request to become a chargeable party at a later point in time. The latter may be called a mechanism to change a chargeable party. The steps for the mechanism are the same as those shown in FIG. 3. Thus, for simplicity of the description, a description thereof will be omitted.

Table 1 shown below illustrates the ChargeableParty API definition in T8 reproduced from 3GPP TS 29.122.

TABLE 1
ChargeableParty API definition in T8

| | | HTTP | |
|---|---|---|---|
| Resource name | Resource URI | method | Meaning |
| Chargeable Party | 3gpp-chargeable-party/v1/{scsAsId}/ | GET | Read all chargeable party transaction |
| Transactions | transactions | | resources for a given SCS/AS |
| | | POST | Create a new chargeable party |
| | | | transaction resource |
| Individual | 3gpp-chargeable-party/v1/{scsAsId}/ | GET | Read a chargeable party transaction |
| Chargeable Party | transactions/{transactionId} | | resource |
| Transaction | | PATCH | Activate or Deactivate sponsoring by a |
| | | | chargeable party. |
| | | DELETE | Delete an existing chargeable party |
| | | | transaction resource |
| Event | {notificationDestination} | POST | Notify the bearer level event(s) from |
| Notification | | | the SCEF to the SCS/AS identified by the |
| | | | notification destination URI |

Table 2 shown below illustrates definition of data type ChargeableParty.

TABLE 2
Definition of data type ChargeableParty

| | | | | Applicability |
|---|---|---|---|---|
| Attribute name | Data type | Cardinality | Description | (NOTE 1) |
| self | Link | 0 . . . 1 | Link to the resource “Individual | |
| | | | Chargeable Party Transaction”. This | |
| | | | parameter shall be supplied by the SCEF | |
| | | | in HTTP responses. | |
| supportedFeatures | SupportedFeatures | 0 . . . 1 | Used to negotiate the supported optional | |
| | | | features of the API as described in | |
| | | | subclause 5.2.7. | |
| | | | This attribute shall be provided in the | |
| | | | POST request and in the response of | |
| | | | successful resource creation. | |
| notificationDestination | Link | 1 | Contains the URI to receive the | |
| | | | notification of bearer level event(s) from | |
| | | | the SCEF. | |
| requestTestNotification | boolean | 0 . . . 1 | Set to true by the SCS/AS to request the | Notification_test_event |
| | | | SCEF to send a test notification as | |
| | | | defined in subclause 5.2.5.3. Set to false | |
| | | | or omitted otherwise. | |
| websockNotifConfig | WebsockNotifConfig | 0 . . . 1 | Configuration parameters to set up | Notification_websocket |
| | | | notification delivery over Websocket | |
| | | | protocol as defined in subclause 5.2.5.4. | |
| ipv4Addr | Ipv4Addr | 0 . . . 1 | Identifies the Ipv4 address. (NOTE 2) | |
| ipv6Addr | Ipv6Addr | 0 . . . 1 | Identifies the Ipv6 address. (NOTE 2) | |
| macAddr | MacAddr48 | 0 . . . 1 | Identifies the MAC address. (NOTE 2) | EthChgParty_5G |
| flowInfo | Array (FlowInfo) | 0 . . . N | Describes the IP flows. (NOTE 2) | |
| ethFlowInfo | Array (EthFlowDescription) | 0 . . . N | Identifies Ethernet packet flows. (NOTE 2) | EthChgParty_5G |
| sponsorInformation | SponsorInformation | 1 | Describes the sponsor information such | |
| | | | as who is sponsoring the traffic. | |
| sponsoringEnabled | boolean | 1 | Indicates sponsoring status. | |
| referenceId | BdtReferenceId | 0 . . . 1 | The reference ID for a previously | |
| | | | selected policy of background data | |
| | | | transfer. | |
| usageThreshold | UsageThreshold | 0 . . . 1 | Time period and/or traffic volume. | |

(NOTE 1):
Properties marked with a feature as defined in subclause 5.5.4 are applicable as described in subclause 5.2.7. If no feature is indicated, the related property applies for all the features.
(NOTE 2):
One of ipv4, ipv6 or MAC address shall be provided. If ipv4 or ipv6 address is provided, IP flow information shall be provided. If MAC address is provided, Ethernet flow information shall be provided.

For the policy activation procedure as shown in FIG. 3, the SCEF/NEF 145 interacts with the PCRF/PCF 120 via a Diameter Rx interface as described in 3GPP TS 29.214. Below it is included the definition for the two main Diameter commands involved, i.e., AA-Request (AAR) and Re-Auth-Request (RAR):

```
<AA-Request> ::= < Diameter Header: 265, REQ, PXY >
      < Session-Id >
      [ DRMP ]
      { Auth-Application-Id }
      { Origin-Host }
      { Origin-Realm }
      { Destination-Realm }
      [ Destination-Host ]
      [ IP-Domain-Id ]
      [ Auth-Session-State ]
      [ AF-Application-Identifier ]
    *[ Media-Component-Description ]
      [ Service-Info-Status ]
      [ AF-Charging-Identifier ]
      [ SIP-Forking-Indication ]
    *[ Specific-Action ]
    *[ Subscription-Id ]
      [ OC-Supported-Features ]
    *[ Supported-Features ]
      [ Reservation-Priority ]
      [ Framed-IP-Address ]
      [ Framed-Ipv6-Prefix ]
      [ Called-Station-Id ]
      [ Service-URN ]
      [ Sponsored-Connectivity-Data ]
      [ MPS-Identifier ]
      [ GCS-Identifier ]
      [ MCPTT-Identifier ]
      [ MCVideo-Identifier ]
      [ IMS-Content-Identifier ]
      [ IMS-Content-Type ]
    *[ Calling-Party-Address ]
      [ Callee-Information ]
      [ Rx-Request-Type ]
    *[ Required-Access-Info ]
      [AF-Requested-Data ]
      [ Reference-Id ]
      [ Pre-emption-Control-Info ]
      [ Origin-State-Id ]
    *[ Proxy-Info ]
    *[ Route-Record ]
    *[ AVP ]
<RA-Request> ::= < Diameter Header: 258, REQ, PXY >
      < Session-Id >
      [ DRMP ]
      { Origin-Host }
      { Origin-Realm }
      { Destination-Realm }
      { Destination-Host }
      { Auth-Application-Id }
    *{ Specific-Action }
      [ OC-Supported-Features ]
    *[ Access-Network-Charging-Identifier ]
      [ Access-Network-Charging-Address ]
  0*2[ AN-GW-Address ]
      [ AN-Trusted ]
    * [ Flows ]
    * [ Subscription-Id ]
          [ Abort-Cause ]
          [ IP-CAN-Type ]
          [ MA-Information ]
          [ NetLoc-Access-Support ]
          [ RAT-Type ]
          [ Sponsored-Connectivity-Data ]
        [ 3GPP-User-Location-Info ]
        [ User-Location-Info-Time ]
          [ 3GPP-MS-TimeZone ]
    * [ RAN-NAS-Release-Cause ]
    * [ 5GS-RAN-NAS-Release-Cause ]
          [ 3GPP-SGSN-MCC-MNC ]
          [ NID ]
          [ TWAN-Identifier]
          [ TCP-Source-Port ]
          [ UDP-Source-Port ]
          [ UE-Local-IP-Address ]
          [ Wireline-User-Location-Info ]
          [ Origin-State-Id ]
    * [ Class ]
    * [ Proxy-Info ]
    * [ Route-Record ]
    * [ AVP ]
```

FIG. 4 is a diagram illustrating an exemplary scenario 40 in which handling infringement of one or more conditions associated with a negotiated BDT policy according to an embodiment of the present disclosure may be applicable. As shown in FIG. 4, a UE 410 (e.g., a vehicle) may be communicatively connected to an AS/SCS/AF (e.g., the AS/SCS/AF 125, for example, a connected vehicle platform), and may perform BDT based on a BDT policy negotiated between the AS/SCS/AF 125 and the SCEF/NEF 145 through the BDT policy negotiation procedure shown in FIG. 2 and activated through the BDT policy activation procedure shown in FIG. 3.

As shown in FIG. 4, the UE 410 moves along a path P, and during the process it goes through cells 400-1, 400-2, 400-3, and 400-4. In the embodiment shown in FIG. 4, all four cells 400-1, 400-2, 400-3, and 400-4 are covered by the area associated with the negotiated BDT policy, and therefore the UE may satisfy all the conditions associated with the negotiated and activated BDT policy when moving in these cells. Thus, a reduced charging rate associated with the BDT policy (e.g., 50% of a normal charging rate) may be applied to the UE 410 when it goes through the cells 400-1, 400-2, 400-3, and 400-4 along the path P.

Later, the UE 410 returns to its original location along another path P′, and during this process it goes through cells 400-5, 400-6, and 400-7. During this process, however, no matter whether the UE 410 infringes any of the conditions associated with the BDT policy, the reduced charging rate associated with the BDT policy (i.e., 50% of the normal charging rate) is still applied to the UE 410 when it goes through the cells 400-5, 400-6, and 400-7, since it is not defined in the current 3GPP specification how to handle infringement of one or more conditions associated with the negotiated BDT policy other than the negotiated time intervals.

In some embodiments of the present disclosure, a mechanism to handle infringement of one or more conditions associated with the negotiated BDT policy is provided. In particular, some embodiments of the present disclosure propose a mechanism in, for example, the PCRF/PCF 120, SCEF/NEF 145, and AS/SCS/AF 125, to monitor infringement of one or more conditions associated with the negotiated BDT by one or more UEs during the BDT, and once such infringement is detected, instead of a reduced charging rate, a normal charging rate is applied to these UEs. In some embodiments, this mechanism can also enable notification of the infringement event to other network nodes, such as the PCRF/PCF 120, SCEF/NEF 145, and/or AS/SCS/AF 125.

Before explaining the proposed mechanism in detail, a BDT policy negotiation procedure according to an embodiment of the present disclosure and a procedure for a UE to attach to a first network node that are involved in the proposed mechanism will be explained first.

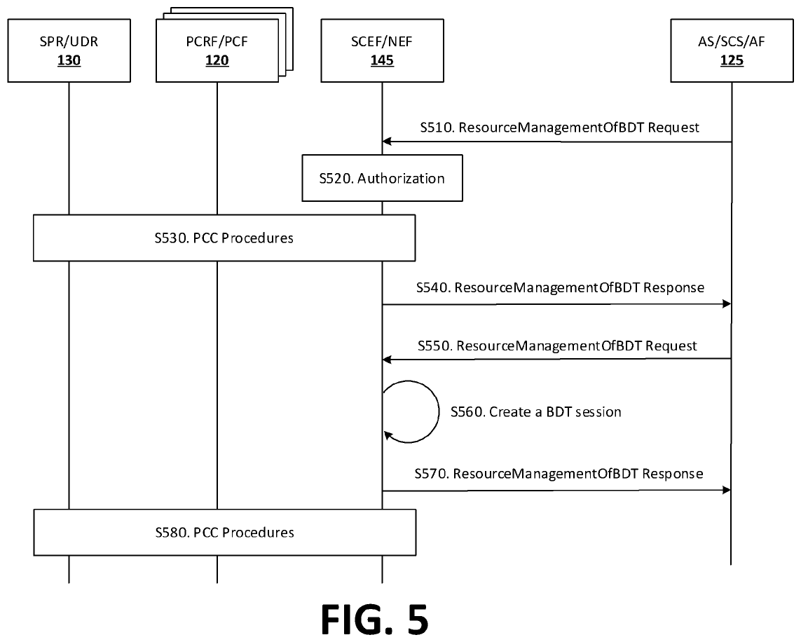

FIG. 5 is a diagram illustrating an exemplary BDT policy negotiation procedure for handling infringement of one or more conditions associated with a negotiated BDT policy according to an embodiment of the present disclosure. However, it is merely an example to illustrate the principle of the present disclosure and therefore the present disclosure is not limited thereto.

As shown in FIG. 5, an AS/SCS/AF 125 tries to negotiate a BDT policy for a UE with a network, which includes a SPR/UDR 130, a PCRF/PCF 120, and a SCEF/NEF 145, and the description of the steps of the procedure is given below.

Step S510. The AS/SCS/AF 125 transmits a BDT request to the SCEF/NEF 145. In some embodiments, the BDT request may be a ResourceManagementOfBDT request which may contain one or more of an identifier of the AS/SCS/AF 125, Volume per UE, Number of UEs, Desired Time Window. Definitions of these parameters may be the same as those described in connection with FIG. 2. Thus, for simplicity of the description, their definitions will not be repeated. The BDT request may further contain a Geographic area, Notification Destination, and an identifier indicating that a notification of infringement of the BDT policy is enabled. The Geographic Area defines an area in which BDT is expected to be conducted. The Notification Destination indicates an identifier of a network node to be notified of an infringement event. In some embodiments, the identifier may be realized with a newly defined attribute bdtInfringementNotifEnabled. Details about the attribute may be found in Table 3 which illustrates definition of data type BDT.

TABLE 3
Definition of Data Type BDT

| | | | | Applicability |
|---|---|---|---|---|
| Attribute name | Data type | Cardinality | Description | (NOTE) |
| self | Link | 0 . . . 1 | Link to the resource “Individual | |
| | | | BDT Subscription”. This parameter | |
| | | | shall be supplied by the SCEF in | |
| | | | HTTP responses. | |
| supportedFeatures | SupportedFeatures | 0 . . . 1 | Used to negotiate the supported | |
| | | | optional features of the API as | |
| | | | described in subclause 5.2.7. | |
| | | | This attribute shall be provided in | |
| | | | the POST request and in the | |
| | | | response of successful resource | |
| | | | creation. | |
| volumePerUE | UsageThreshold | 1 | Identifies the data volume expected | |
| | | | to be transferred per UE. | |
| numberOfUEs | integer | 1 | Identifies the number of UEs. | |
| desiredTimeWindow | TimeWindow | 1 | Identifies the time interval. | |
| locationArea | LocationArea | 0 . . . 1 | Identifies the area within which the | Bdt |
| | | | SCS/AS requests the number of UE. | |
| locationArea5G | LocationArea5G | 0 . . . 1 | Identifies the area within which the | LocBdt_5G |
| | | | AF requests the number of UE. | |
| referenceId | BdtReferenceId | 0 . . . 1 | Identifies a selected policy of | |
| | | | background data transfer. | |
| transferPolicies | array(TransferPolicy) | 0 . . . N | Identifies an offered transfer policy. | |
| selectedPolicy | integer | 0 . . . 1 | Identity of the selected background | |
| | | | data transfer policy. Shall not be | |
| | | | present in initial message | |
| | | | exchange, can be provided by NF | |
| | | | service consumer in a subsequent | |
| | | | message exchange. | |
| externalGroupId | ExternalGroupId | 0 . . . 1 | Identifies a group of users. | Group_Id |
| notificationDestination | Link | 0 . . . 1 | Contains the URI to receive the | BdtNotification_5G |
| | | | BDT notification from the NEF. | |
| warnNotifEnabled | boolean | 0 . . . 1 | Indicates whether the BDT warning | BdtNotification_5G |
| | | | notification is enabled or not. | |
| | | | If it is set to true, the BDT warning | |
| | | | notification is enabled; if it is set to | |
| | | | false or absent, the BDT warning | |
| | | | notification is disabled. | |
| bdtInfringementNotifEnabled | boolean | 0 . . . 1 | Indicates whether the BDT infringement | |
| | | | notification is enabled or not. | |
| | | | If it is set to true, the BDT | |
| | | | infringement notification is enabled; | |
| | | | if it is set to false or absent, the | |
| | | | BDT infringement notification is disabled. | |

Step S520. The SCEF/NEF 145 authorizes the BDT request transmitted from the AS/SCS/AF 125.

Step S530. PCC procedures are performed at the SPR/UDR 130, PCRF/PCF 120, and SCEF/NEF 145. For example, the SCEF/NEF 145 selects an available PCRF/PCF 120 and triggers to further negotiate the BDT policy with the selected PCRF/PCF 120. For example, the SCEF/NEF 145 forwards the parameters contained in the BDT request to the PCRF/PCF 120. The PCRF/PCF 120 responds to the SCEF/NEF 145 with one or more possible BDT policies and reference IDs identifying these BDT policies.

Step S540. The SCEF/NEF 145 transmits a BDT response to the AS/SCS/AF 125. In some embodiments, the BDT response may be a ResourceManagementOfBDT response, which may contain the received reference IDs identifying the BDT policies and the corresponding BDT policies. The AS/SCS/AF 125 stores the reference IDs and the corresponding BDT policies for the future interaction with the PCRF/PCF 120.

Step S550. The AS/SCS/AF 125 selects one of BDT policies when more than one reference IDs are received and transmits another BDT request (e.g., a ResourceManagementOfBDT request) to the SCEF/NEF 145 so as to inform the SCEF/NEF 145 and PCRF/PCF 120 about the selected BDT policy. Here, the BDT request contains the identifier of the AS/SCS/AF 125, the reference ID identifying the selected BDT policy and the selected BDT policy itself.

Step S560. The SCEF/NEF 145 creates a BDT session object, which contains the selected BDT policy and the reference ID identifying the selected BDT policy, internally. The SCEF/NEF 145 also creates a placeholder of a UE List inside the BDT session so as to store identifiers of UEs for BDT policy activation. The BDT session object may also contain a current available data volume which indicates the remaining total volume allowed for the BDT session. In some embodiments, the current available data volume may be indicated by an attribute Total Volume Allowed. The current available data volume has an initial value equal to the Total Data Volume=Volume per UE*Number of UEs.

Step S570. The SCEF/NEF 145 transmits a BDT response (e.g., a ResourceManagementOfBDT response) to the AS/SCS/AF 125 so as to confirm the BDT policy selection.

Step S580. PCC procedures are performed at the SPR/UDR 130, PCRF/PCF 120, and SCEF/NEF 145. For example, the SCEF/NEF 145 continues the BDT policy negotiation procedure with the PCRF/PCF 120.

The present disclosure also introduces a data type for the SCEF/NEF 145 to notify infringements events to the AS/SCS/AF 125. The main data structure of this interface is NotificationData, details for which is shown in the following Table 4.

TABLE 4
Definition of Data Type NotificationData

| Attribute name | Data type | Cardinality | Description |
|---|---|---|---|
| bdtReferenceId | Link | 1 | |
| chargeablePartyTransactionId | Link | 1 | Link to the transaction resource to which this |
| | | | notification is related. |
| eventReports | array(EventReport) | 1 . . . N | Contains the reported event and applicable |
| | | | information |

Definition of the data type eventReport shown in Table 4 is shown in Table 5.

TABLE 5
Definition of the data type eventReport

| Attribute name | Data type | Cardinality | Description |
|---|---|---|---|
| event | Event | 1 | Indicates the event reported |
| | | | by the SCEF. |

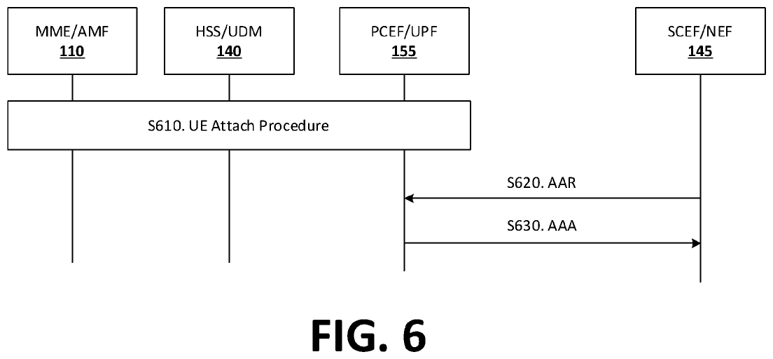

After negotiating the BDT policy between the AS/SCS/AF 125 and the SCEF/NEF 145, once the UE attaches to 3GPP network, the UE may attach to the SCEF/NEF 145 with the procedure shown in FIG. 6, which is a message flow diagram illustrating an exemplary procedure for UE to attach to a first network node in which handling infringement of one or more conditions associated with a negotiated BDT policy according to an embodiment of the present disclosure may be applicable. With this procedure, the SCEF/NEF 145 can keep the mapping between an IP Address of a UE and an identifier of the UE such as an International Mobile Subscriber Identity (IMSI). The description of the steps of the procedure is given below.

Step S610. A UE attaches to 3GPP network.

Step S620. The PCEF/UPF 155 transmits, to the SCEF/NEF 145, an Authentication/Authorization Request (AAR) message (Radius) which contains an IP address of a UE and an identifier of the UE such as an IMSI.

Step S630. The SCEF/NEF 145 transmits, to the PCEF/UPF 155, an Authentication/Authorization Answer (AAA) message (Radius).

With this procedure, the SCEF/NEF 145 can keep the mapping between the identifier of the UE and the IP address of the UE.

Now the mechanism to handle infringement of one or more conditions associated with the negotiated BDT policy proposed in some embodiments of the present disclosure is explained in detail taking the following three infringement scenarios as examples:
a negotiated number of UEs being exceeded;
being out of a negotiated geographic area; and
a negotiated total data volume being exceeded.

However, the present disclosure is not limited thereto. In some other embodiments, other conditions associated with the negotiated BDT policy may be involved.

### The Number of UEs Scenario

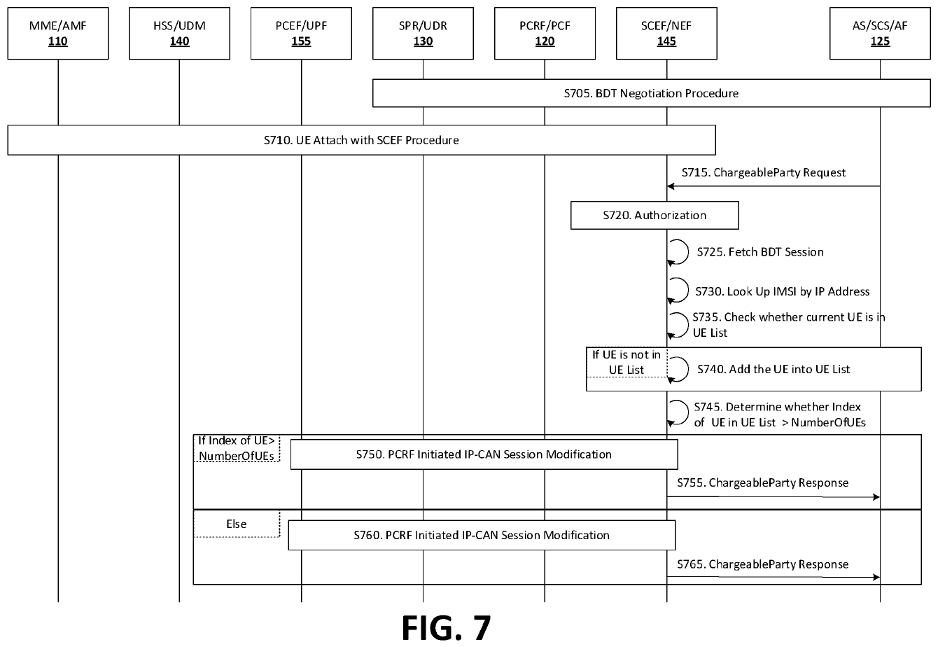

FIG. 7 is a diagram illustrating an exemplary procedure for handling infringement of a negotiated number of UEs associated with a negotiated BDT policy according to an embodiment of the present disclosure. However, it is merely an example to illustrate the principle of the present disclosure and therefore the present disclosure is not limited thereto.

The description of the steps of the procedure is given below.

Step S705. The AS/SCS/AF 125 triggers a BDT negotiation procedure, for example, as described in connection with FIG. 5.

Step S710. A UE attaches with the SCEF/NEF 145 through a procedure, for example, as described in connection with FIG. 6. With this procedure, the SCEF/NEF 145 can maintain a table that maps an IP address of the UE to an identifier of the UE.

Step S715. The AS/SCS/AF 125 transmits, to the SCEF/NEF 145, a BDT request (e.g., a ChargeableParty request). The BDT request may contain one or more of an identifier of the AS/SCS/AF 125, an IP address of the UE, flow information, sponsor information, notification destination, and a reference ID of a BDT policy negotiated with the BDT policy negotiation procedure shown in FIG. 5.

Step S720. The SCEF/NEF 145 authorizes the BDT request from the AS/SCS/AF 125.

Step S725. The SCEF/NEF 145 fetches a BDT session, for example, a BDT session that is created at Step S560 during the BDT policy negotiation procedure described in connection with FIG. 5, using the reference ID so that the SCEF/NEF 145 gets the details of the negotiated BDT policy including one or more of the Time Window, Number of UEs, Geographic Area, Volume per UE, and a UE List, etc.

Step S730. The SCEF/NEF 145 looks up the IP address in the table that maps the IP address to the identifier (e.g., an IMSI), thereby determining the identifier of the UE based on its IP address.

Step S735. The SCEF/NEF 145 determines whether the UE is in the UE List or not, for example, by comparing its identifier with those in the UE list.

Step S740. The SCEF/NEF 145 adds the identifier of the UE into the UE List, in response to determining that the UE is not in the UE List. Thus, the UE list contains all the UEs that participate in BDT sessions. Meanwhile, an index is assigned to the UE. In some embodiments, the UEs in the UE list are indexed in a chronological order of their corresponding BDT sessions. It is to be noted that, in some embodiments, a plurality of BDT sessions for the same UE is possible, so the infringement monitoring or detection is not done based on the number of ChargeableParty requests but on the number of UEs participating in BDT sessions.

Step S745. The SCEF/NEF 145 determines whether the index of the UE in the UE list is greater than the negotiated number of UEs, for example, that negotiated during the BDT policy negotiation procedure in FIG. 5 or not.

Step S750. If the index of the UE in the UE list is greater than the negotiated number of UEs, the SCEF/NEF 145 determines that the UE infringes the condition of Number of UEs associated with the BDT policy. In response to the determination, the SCEF/NEF 145 triggers updating of a charging rate applied for the UE, for example, updating to the normal charging rate. For example, the SCEF/NEF 145 executes a procedure of PCRF initiated IP-CAN session modification with an indication of exceeding number of UEs, so as to activate the negotiated BDT policy to update the charging rate. A new Attribute Value Pair (AVP) BdtInfringement with value 0 (NumberOfUEsExceeded) as described in section Rx extensions (in case of PCF, it may be a new attribute in Npcf_PolicyAuthorization) is included in the Rx AAR request indicating to the PCRF/PCF 120 that the negotiated number of UEs is exceeded, so the PCRF/PCF 120 shall apply a proper charging rate but not a reduced charging rate negotiated during the BDT policy negotiation procedure described in connection with FIG. 5.

Step S755. The SCEF/NEF 145 notifies the AS/SCS/AF 125 of the event that the negotiated Number of UEs is exceeded. In some embodiments, the SCEF/NEF 145 transmits, to the AS/SCS/AF 125, a BDT response (e.g., a ChargeableParty response) with a notification of the event that the negotiated Number of UEs is exceeded.

Step S760. If the index of the UE in the UE list is not greater than the negotiated number of UEs, the SCEF/NEF 145 determines that the UE does not infringe the condition of Number of UEs associated with the BDT policy, and thus a reduced charging rate shall be applied to the UE. For example, the SCEF/NEF 145 executes the standard PCRF initiated IP-CAN session modification procedure to activate the negotiated BDT policy.

Step S765. The SCEF/NEF 145 transmits a BDT response (e.g., a ChargeableParty response) to the AS/SCS/AF 125.

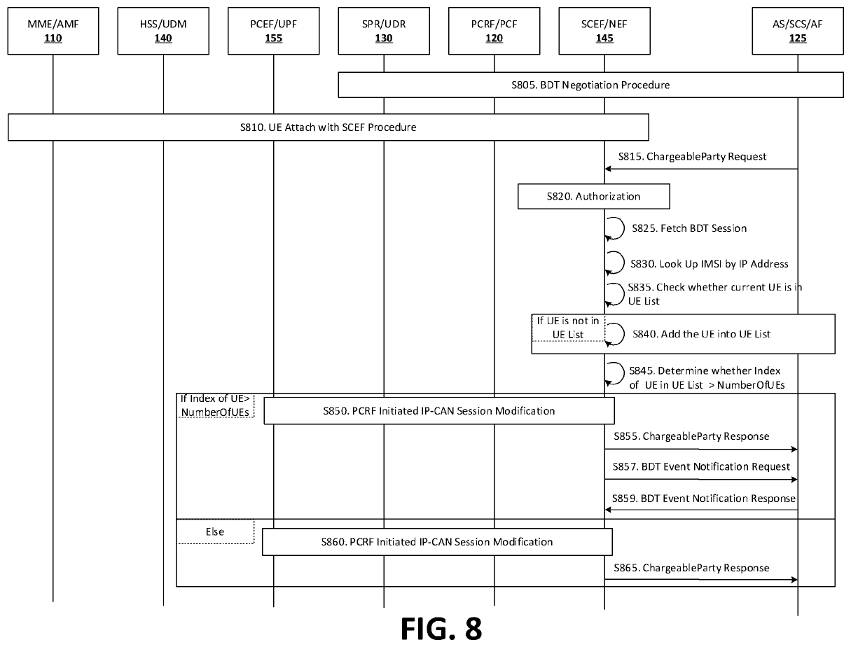

Alternatively, the SCEF/NEF 145 can also use a BDT event notification to notify the AS/SCS/AF 125 as shown in FIG. 8, which is a diagram illustrating another exemplary procedure for handling infringement of a negotiated number of UEs associated with a negotiated BDT policy according to another embodiment of the present disclosure.

Steps S805, S810, S815, S820, S825, S830, S835, S840, S845, S850, S860, and S865 shown in FIG. 8 are the same as Steps S705, S710, S715, S720, S725, S730, S735, S740, S745, S750, S760, and S765 shown in FIG. 7 respectively. Thus, for simplicity of the description, their description will not be repeated.

As shown in FIG. 8, the SCEF/NEF 145 notifies the AS/SCS/AF 125 of the event that the negotiated Number of UEs is exceeded by transmitting, to the AS/SCS/AF 125, a BDT event notification request indicating the event at Step S857, instead of Step 855. In response to receiving the BDT event notification request, the AS/SCS/AF 125 transmits a BDT event notification response to confirm the notification at Step S859.

Thus, with the above mechanism, if a UE infringes the condition of Number of UEs associated with a negotiated BDT policy, the charging rate applied to the UE would be updated to a reasonable one, such as a normal charging rate, and such an infringement may be reported to the AS/SCS/AF 125.

### The Geographic Area Scenario

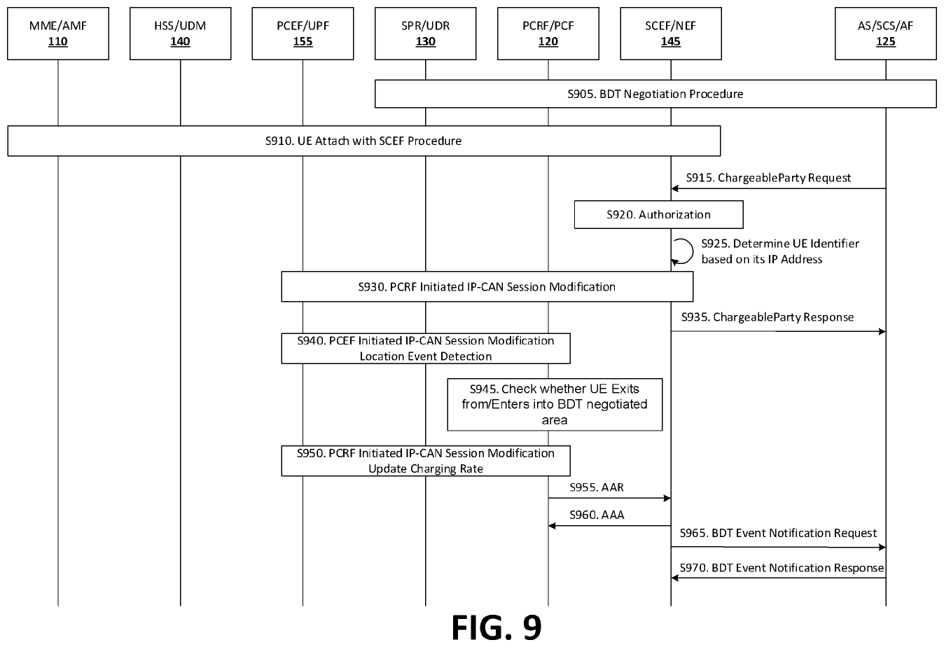

FIG. 9 is a diagram illustrating an exemplary procedure for handling infringement of a negotiated geographic area associated with a negotiated BDT policy according to an embodiment of the present disclosure. However, it is merely an example to illustrate the principle of the present disclosure and therefore the present disclosure is not limited thereto.

The description of the steps of the procedure is given below.

Step S905. The AS/SCS/AF 125 triggers a BDT negotiation procedure, for example, that described in connection with FIG. 5.

Step S910. A UE attaches with the SCEF/NEF 145 through a procedure, for example, that described in connection with FIG. 6. With this procedure, the SCEF/NEF 145 can maintain a table that maps an IP address of the UE to an identifier of the UE.

Step S915. The AS/SCS/AF 125 transmits, to the SCEF/NEF 145, a BDT request (e.g., a ChargeableParty request). The BDT request may contain one or more of an identifier of the AS/SCS/AF 125, an IP address of the UE, flow information, sponsor information, notification destination, and a reference ID of a BDT policy negotiated with the BDT policy negotiation procedure shown in FIG. 5.

Step S920. The SCEF/NEF 145 authorizes the BDT request from the AS/SCS/AF 125.

Step S925. The SCEF/NEF 145 determines the Identifier of the UE (e.g., an IMSI) based on the IP address of the UE by looking up the IP address in the table that maps the IP address to the identifier.

Step S930. The SCEF/NEF 145 transmits a subscription request for subscribing notification of the event that the UE exits from or enters into the negotiated geographic area. The subscription request may comprise an indicator indicating the negotiated geographic area and the identifier of the UE. In some embodiments, the SCEF/NEF 145 executes the PCRF initiated IP-CAN session modification procedure, during which a subscription request for subscribing notification of the event that the UE exits from or enters into the negotiated geographic area is included in the Rx message transmitted to the PCRF/PCF 120. This may be done by defining a new proprietary value (notifBdtNegotiatedAreaLocationEvent) for Specific-Action-AVP. A similar procedure can be used in case of the NEF 145 by invoking Npcf_PolicyAuthorization towards the PCF 120. With this PCRF initiated IP-CAN session modification procedure, the PCRF/PCF 120 subscribes to the event UE-LOCATION-CHANGE or PRA-CHANGE over the Gx interface towards PGW (in case it is not already subscribed).

Step S935. The SCEF/NEF 145 transmits, to the AS/SCS/AF 125, a BDT response (e.g., a ChargeableParty response) containing a transactionID.

Step S940. When the UE exits from or enters into the negotiated geographic area, the PGW (or the PCEF) initiates a PCEF initiated IP-CAN session modification procedure which can notify the PCRF/PCF 120 of the event that the UE exits from or enters into the negotiated geographic area.

Step S945. The PCRF/PCF 120 determines whether the UE with the identifier determined at Step S925 exits from or enters into the negotiated geographic area. If not, the following steps in the flow may be skipped.

Step S950. The PCRF/PCF 120 performs a PCRF initiated IP-CAN session modification procedure so as to update the charging rate. In the case where the UE exits from the negotiated geographic area, the charging rate would be updated to a normal one, while in the case where the UE enters into the negotiated geographic area, it is determined that the UE satisfies the condition of the negotiated geographic area, and thus the charging rate would be updated to a reduced one.

Step S955. The PCRF/PCF 120 notifies the event that the UE exits from or enters into the negotiated geographic area to the SCEF/NEF 145. In some embodiments, this is done by invoking Rx AAR message including Specific-Action-AVP with the new proprietary value of notifBdtNegotiatedAreaLocationEvent and a new AVP NotifBdtNegotiatedAreaLocationInfo indicating the event of enter into/exit from the negotiated geographic area.

Step S960. The SCEF/NEF 145 transmits an AAA to the PCRF/PCF 120.

Step S965. The SCEF/NEF 145 transmits, to the AS/SCS/AF 125, a BDT Event Notification request including the transactionID obtained at Step S925 and an event report indicating that the UE exits from or enters into the negotiated geographic area.

Step S970. The AS/SCS/AF 125 transmits, to the SCEF/NEF 145, a BDT event notification response to confirm the notification.

Thus, with the above mechanism, if a UE infringes the condition of a negotiated Geographic Area associated with the negotiated BDT policy, the charging rate applied to the UE would be updated to a reasonable one, such as a normal charging rate.

### The Total Data Volume Scenario

The present embodiment is based on the SCEF/NEF 145 maintaining the current available data volume which indicates the remaining data volume for all the BDT sessions associated with the negotiated BDT policy. That is, the SCEF/NEF 145 aggregates the data volume consumption of all BDT sessions associated with the negotiated BDT policy and determines whether the total data volume is exceeded.

To realize the above function, when the SCEF/NEF 145 invokes the PCRF initiated IP-CAN session modification procedure to activate the negotiated BDT policy, the SCEF/NEF 145 includes a subscription to USAGE_REPORT specific-action such that it is to be notified when the UE consumes a certain data volume (e.g., a Volume Slice) provided in the request within Granted-Service-Unit AVP.

Then, each time the PCRF initiated IP-CAN session modification procedure is invoked, the SCEF/NEF 145 deducts the Volume Slice from the current available data volume which has an initial value equal to the total data volume, and the value of which is reduced whenever a volume slice is allocated for a BDT session for a UE associated with the BDT policy.

It is to be noted that the selected Volume Slice should be less than the negotiated Volume per UE (e.g., ½ or ¼ of the Volume per UE) in order to allow to assign the Volume per UE to each UE.

When the SCEF/NEF 145 is notified by the PCRF/PCF 120 that the Volume Slice has been already consumed for a certain BDT session, the SCEF/NEF 145 deducts a new Volume Slice from the current available data volume and initiates a new PCRF initiated IP-CAN session modification procedure to subscribe again with the PCRF/PCF 120 to the event USAGE_REPORT so as to be notified that when the Volume Slice is consumed again by the UE.

It is to be note that, if the BDT session is terminated before the consumption of the volume slice, the PCRF/PCF 120 will include the consumed volume in the notification about the BDT session termination and then the SCEF/NEF 145 may add, to the current available data volume, the volume that is not consumed.

When the SCEF/NEF 145 realizes that the negotiated total data volume has been consumed (i.e., the current available data volume has reached 0 and the PCRF/PCF 120 notifies that the assigned Volume Slice has been consumed), the SCEF/NEF 145 notifies:
the AS/SCS/AF 125 that although the number of UEs and/or the geographic area has not been infringed during the negotiated time window, the negotiated total data volume has been exceeded, so the network should apply normal charging rate, but not a reduced one, to the traffic consumed by those UEs (even when the negotiated time window has not been expired).
the PCRF/PCF 120 which maintains the BDT sessions associated with the negotiated BDT policy that the negotiated total data volume has been exceeded, so the network should apply normal charging rate, but not a reduced one, to the traffic consumed by those UEs (even when the negotiated time window has not been expired). This notification may be done by reusing the PCRF initiated IP-CAN session modification procedure but including a new AVP indicating the event to the PCRF/PCF 120.

Additionally, if a new chargeable Party request which contains the same reference ID is received by the SCEF/NEF 145, once the total data volume has been exceeded, the SCEF/NEF 145 will notify the AS/SCS/AF 125 (or just include new information in the Chargeable Party response) that a normal charging rate is to be applied.

It is to be noted that, according to 3GPP, the subscription to USAGE_REPORT by the AS/SCS/AF 125 is associated with the sponsorship of the flows, so the Granted-Service-Unit AVP is included in the Sponsored-Connectivity-Data AVP, together with Sponsor-Identity and Application-Service-Provider-Identity AVPs. So, if received, the PCRF/PCF 120 will apply sponsorship. However, for the case where the SCEF/NEF 145 does not want to apply sponsorship, but just want to be notified when the UE consumes a certain data volume for which a reduced charging rate is applied. For this reason, it is proposed to include a new AVP within Sponsored-Connectivity-Data indicating that the monitoring of the usage consumption is not related to Sponsorship, so the PCRF/PCF 120 will not apply sponsorship for the corresponding flows, but only monitor the data consumption.

In the case where the AS/SCS/AF 125 also requests the sponsorship of the flows with a threshold in the invocation of ChargeableParty request, the SCEF/NEF 145 will still calculate the Volume Slice to be reported by the PCRF/PCF 120. However, in this case, the SCEF/NEF 145 will request sponsorization as defined in 3GPP just skipping the new AVP but maintaining the account of the volume consumed by the UE up to the threshold. For example, if the threshold requested by the AS/SCS/AF 125 is 4 times the VolumeSlice, the SCEF/NEF 145 will notify the AS/SCS/AF 125 for the threshold when the PCRF/PCF 120 notifies 4 times the consumption of the VolumeSlice.

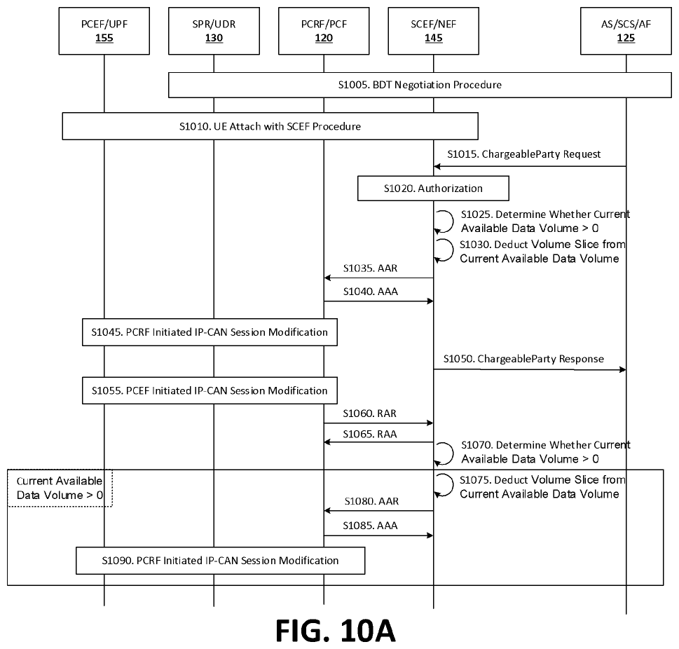

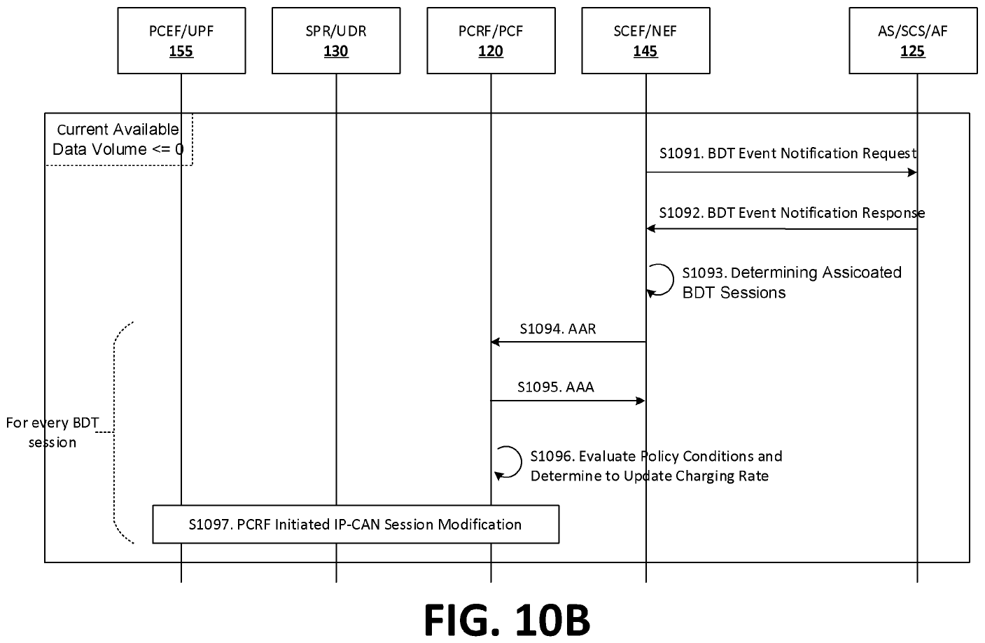

FIGS. 10A and 10B are diagrams illustrating an exemplary procedure for handling infringement of a negotiated total data volume associated with a negotiated BDT policy according to an embodiment of the present disclosure. However, it is merely an example to illustrate the principle of the present disclosure and therefore the present disclosure is not limited thereto.

The description of the steps of the procedure is given below.

Step S1005. The AS/SCS/AF 125 triggers the BDT negotiation procedure described in connection with FIG. 5.

Step S1010. A UE attaches with the SCEF/NEF 145 through the procedure described in connection with FIG. 6. With this procedure, the SCEF/NEF 145 can maintain a table that maps an IP address of the UE to an identifier of the UE.

Step S1015. The AS/SCS/AF 125 transmits, to the SCEF/NEF 145, a BDT request (e.g., a ChargeableParty request). The BDT request may contain one or more of an identifier of the AS/SCS/AF 125, an IP address of the UE, flow information, sponsor information, notification destination, and a reference ID of a BDT policy negotiated with a BDT policy negotiation procedure, for example, that shown in FIG. 5.

Step S1020. The SCEF/NEF 145 authorizes the BDT request from the AS/SCS/AF 125.

Step S1025. The SCEF/NEF 145 determines whether the current available data volume is not greater than zero, so as to determine whether the total data volume has been consumed yet. If the negotiated total data volume has already been consumed, the method continues to Step S1050, and the SCEF/NEF 145 transmits, to the AS/SCS/AF 125, a message for notifying the event that the total data volume has been consumed.

Step S1030. The SCEF/NEF 145 deducts a certain data volume (e.g., a Volume Slice) from the current available data volume.

Step S1035. The SCEF/NEF 145 transmits, to the PCRF/PCF 120, a subscription request for subscribing notification of an event that the volume slice is consumed by the BDT session. In some embodiments, this is done by transmitting, by the SCEF/NEF 145, an AAR (e.g., an Rx AAR-I message) to the PCRF/PCF 120 to activate the negotiated BDT policy. In addition, the SCEF/NEF 145 includes the Volume Slice in Granted-Service-Unit AVP in the Sponsored-Connectivity-Data AVP together with new AVP ReportingForBdtInfringement. The Specific-Action AVP in the AAR is set to the value USAGE_REPORT so as to request a notification from the PCRF/PCF 120 when the Volume Slice has been consumed by the UE.

Step S1040. The PCRF/PCF 120 transmits an AAA (e.g., an Rx AAR-I message) to the SCEF/NEF 145.

Step S1045. The PCRF/PCF 120 detects whether the volume slice is consumed by the UE. In some embodiments, the PCRF/PCF 120 executes a PCRF initiated IP-CAN session modification procedure to activate the negotiated BDT policy associated with a negotiated reduced charging rate. During this procedure, the PCEF/UPF 155 is requested by the PCRF/PCF 120 notify it of the event that the Volume Slice has been consumed.

Step S1050. The SCEF/NEF 145 transmits a BDT response (e.g., a ChargeableParty response) to the AS/SCS/AF 125.

It is to be noted that in the case where the negotiated total data volume has been already consumed, the SCEF/NEF 145 rejects the request and includes the notification about totalVolumeExceeded in the ChargeableParty response.

Step S1055. When the PCEF/PCF 120 detects that the Volume Slice has been consumed by any of the BDT sessions associated with the BDT policy that has been activated, the PCEF/UPF 155 reports the event to the PCRF/PCF 120, for example, by initiating the PCEF initiated IP-CAN session Modification procedure as described in 3GPP TS 23.203.

Step S1060. The PCRF/PCF 120 transmits an Rx RAR message to the SCEF/NEF 145 to report the event that the Volume Slice has been consumed.

Step S1065. The SCEF/NEF 145 transmits an Rx RAA to the PCRF/PCF 120.

Step S1070. The SCEF/NEF 145 determines whether the current available data volume is greater than zero. If yes, the method continues at Step S1075, otherwise goes to Step S1091 shown in FIG. 10B.

Steps S1075-S1090. The SCEF/NEF 145 deducts another Volume Slice from the current available data volume and requests the PCRF/PCF 120 to notify it when the Volume Slice has been consumed by the UE again. These steps are similar to the ones from Steps S1030-1045, and will be repeated until the current available data volume is not greater than zero.

Step S1091. The SCEF/NEF 145 transmits, to the AS/SCS/AF 125, a BDT event notification request which contains the reference ID of the selected BDT policy and exceedTotalVolume event indicating that the total data volume has been consumed.

Step S1092. The AS/SCS/AF 125 transmits a BDT event notification response to the SCEF/NEF 145.

Step S1093. The SCEF/NEF 145 determines all BDT sessions associated with the BDT policy in response to determining that the total data volume has been consumed. For each of the determined BDT sessions, the SCEF/NEF 145 executes the Steps S1094-S1097, so as to notify the PCRF/PCF 120 that the negotiated total data volume has been consumed and the charging rate should be updated to a normal one.

Step S1094. The SCEF/NEF 145 transmits, to the PCRF/PCF 120, an Rx AAR-U message which contains an AVP BdtInfringement (TotalVolumeExceed).

Step S1095. The PCRF/PCF 120 transmits an Rx AAA-U message to the SCEF/NEF 145.

Step S1096. The PCRF/PCF 120 evaluates the conditions associated with the BDT policy and determines to update the charging rate to a normal one.

Step S1097. The PCRF/PCF 120 contacts with PCEF/UPF 155 and performs the PCRF initiated IP-CAN session Modification procedure so as to update the charging rate to a normal one.

Thus, with the above mechanism, if a UE infringes the condition of a negotiated total data volume associated with the negotiated BDT policy, the charging rate applied to the UE would be updated to a reasonable one, such as a normal charging rate.

It can be seen that the present disclosure extends current 3GPP Rx interface by:
adding a new AVP “BdtInfringement” into the Diameter AAR command request communicated between the SCEF/NEF 145 and the PCRF/PCF 120. When present, this AVP indicates to the PCRF/PCF 120 that the reduced charging rating associated with the negotiated BDT policy identified with a reference ID is no longer applicable due to the infringement of one or more of the negotiated conditions associated with the BDT policy.
adding a new AVP “ReportingForBdtInfringement” into the Sponsored-Connectivity-Data AVP.
adding a new value of “notifBdtNegotiatedAreaLocationEvent” in the existing Specific-Action AVP.

```
<AA-Request> ::= < Diameter Header: 265, REQ, PXY >
    < Session-Id >
    [ DRMP ]
    { Auth-Application-Id }
    { Origin-Host }
    { Origin-Realm }
    { Destination-Realm }
    [ Destination-Host ]
    [ IP-Domain-Id ]
    [ Auth-Session-State ]
    [ AF-Application-Identifier ]
  *[ Media-Component-Description ]
    [ Service-Info-Status ]
    [ AF-Charging-Identifier ]
    [ SIP-Forking-Indication ]
  *[ Specific-Action ]
  *[ Subscription-Id ]
    [ OC-Supported-Features ]
  *[ Supported-Features ]
    [ Reservation-Priority ]
    [ Framed-IP-Address ]
    [ Framed-Ipv6-Prefix ]
    [ Called-Station-Id ]
    [ Service-URN ]
    [ Sponsored-Connectivity-Data ]
    [ MPS-Identifier ]
    [ GCS-Identifier ]
    [ MCPTT-Identifier ]
    [ MCVideo-Identifier ]
    [ IMS-Content-Identifier ]
    [ IMS-Content-Type ]
  *[ Calling-Party-Address ]
    [ Callee-Information ]
    [ Rx-Request-Type ]
  *[ Required-Access-Info ]
    [AF-Requested-Data ]
    [ Reference-Id ]
    [ Pre-emption-Control-Info ]
    [ BdtInfringement ]
    [ Origin-State-Id ]
  *[ Proxy-Info ]
  *[ Route-Record ]
  *[ AVP ]
```

Here, the BdtInfringement AVP may be a new AVP of a data type Unsigned32, and indicates the reason of the infringement. The following values may be defined:
0 (NumberOfUEsExceeded)
1 (TotalVolumeExceeded)

A new AVP (ReportingForBdtInfringement) is proposed to be included in Sponsored-Connectivity-Data for the cases where the SCEF/NEF 145 just wants to monitor the consumption of some data volume by the UE but not apply sponsorship. In this case, ReportingForBdtInfringement is provided, but none of the Sponsor-Identity, the Application-Service-Provider-Identity, and the Sponsoring-Action AVPs Is provided.

Sponsored-Connectivity-Data::= < AVP Header: 530 >

```
  [ Sponsor-Identity ]
  [ Application-Service-Provider-Identity ]
  [ Granted-Service-Unit ]
  [ Used-Service-Unit ]
  [ Sponsoring-Action ]
  [ ReportingForBdtInfringement ]
*[ AVP ]
```

```
<RA-Request> ::= < Diameter Header: 258, REQ, PXY >
      < Session-Id >
      [ DRMP ]
      { Origin-Host }
      { Origin-Realm }
      { Destination-Realm }
      { Destination-Host }
      { Auth-Application-Id }
    *{ Specific-Action }
      [ OC-Supported-Features ]
    *[ Access-Network-Charging-Identifier ]
      [ Access-Network-Charging-Address ]
  0*2[ AN-GW-Address ]
      [ AN-Trusted ]
    *[ Flows ]
    *[ Subscription-Id ]
      [ Abort-Cause ]
      [ IP-CAN-Type ]
      [ MA-Information ]
      [ NetLoc-Access-Support ]
      [ RAT-Type ]
      [ Sponsored-Connectivity-Data ]
    [ 3GPP-User-Location-Info ]
    [ User-Location-Info-Time ]
      [ 3GPP-MS-TimeZone ]
    *[ RAN-NAS-Release-Cause ]
    *[ 5GS-RAN-NAS-Release-Cause ]
      [ 3GPP-SGSN-MCC-MNC ]
      [ NID ]
      [ TWAN-Identifier ]
      [ TCP-Source-Port ]
      [ UDP-Source-Port ]
      [ UE-Local-IP-Address ]
      [ Wireline-User-Location-Info ]
      [ Origin-State-Id ]
    *[ Class ]
    *[ Proxy-Info ]
    *[ Route-Record ]
    *[ AVP ]
```

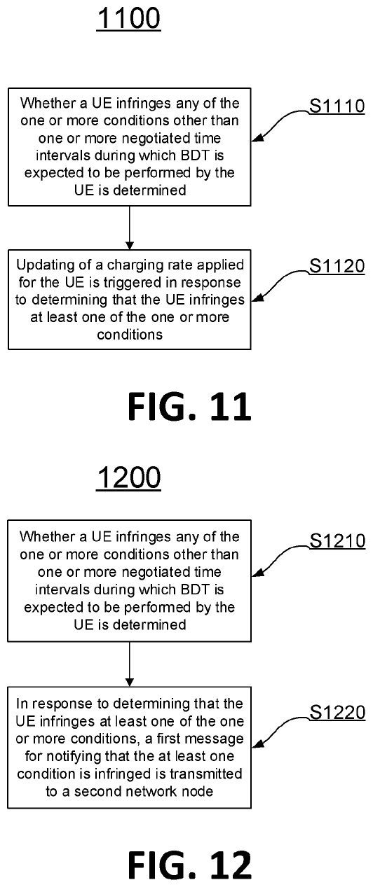

FIG. 11 is a flow chart of an exemplary method 1100 at a first network node for handling infringement of one or more conditions associated with a negotiated BDT policy according to an embodiment of the present disclosure. The method 1100 may be performed at the first network node (e.g., SCEF/NEF 145 in FIGS. 5-10B). The method 1100 may comprise step S1110 and S1120. However, the present disclosure is not limited thereto. In some other embodiments, the method 1100 may comprise more steps, less steps, different steps, or any combination thereof. Further the steps of the method 1100 may be performed in a different order than that described herein. Further, in some embodiments, a step in the method 1100 may be split into multiple sub-steps and performed by different entities, and/or multiple steps in the method 1100 may be combined into a single step.

The method 1100 may begin at step S1110 where whether a UE infringes any of the one or more conditions other than one or more negotiated time intervals during which BDT is expected to be performed by the UE is determined.

In some embodiments, the method 1100 may further comprise a step S1120 where updating of a charging rate applied for the UE may be triggered in response to determining that the UE infringes at least one of the one or more conditions.

In some embodiments, the step S1120 of triggering updating of the charging rate applied for the UE may include triggering applying a charging rate for the UE that is different from a negotiated charging rate associated with the BDT policy in response to determining that the UE infringes the at least one condition.

In some embodiments, the one or more conditions may include at least one of: a negotiated number of UEs expected to participate in data transfer associated with the BDT policy; and a total data volume associated with the BDT policy.

In some embodiments, the method 1100 may further include transmitting, to a second network node, a first message for notifying that the at least one condition is infringed in response to determining that the UE infringes the at least one condition.

In some embodiments, the step S1120 of triggering updating of a charging rate applied for the UE may include transmitting, to a third network node, a second message indicating the infringement of the at least one condition by the UE when the at least one condition includes the negotiated number of UEs and/or the total data volume.

In some embodiments, the step S1110 of determining whether the UE infringes any of the one or more conditions may include determining whether an index of the UE in a UE list is greater than the negotiated number of UEs or not, the UE list comprising all UEs that participate in BDT sessions and the UEs in the UE list being indexed in a chronological order of their corresponding BDT sessions. In some embodiments, the step S1110 of determining whether the UE infringes any of the one or more conditions may further include determining that the UE infringes the at least one condition in response to determining that the index of the UE in the UE list is greater than the negotiated number of UEs.

In some embodiments, before the step S1110 of determining whether the UE infringes any of the one or more conditions, the method 1100 may further include receiving, from the second network node, a fourth message for activating a BDT session for the UE; determining an identifier of the UE from the fourth message. In some embodiments, before the step S1110 of determining whether the UE infringes any of the one or more conditions, the method 1100 may further include adding the identifier of the UE into the UE list in response to determining that the UE is not in the UE list at least partially based on the identifier of the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the fourth message may include a reference ID identifying the BDT policy. In some embodiments, before the step of adding the identifier of the UE into the UE list, the method 1100 further may include retrieving the UE list by using the reference ID.

In some embodiments, after the step receiving, from the second network node, a fourth message for activating a BDT session for the UE, the method may include authenticating the fourth message to verify if the second network node is allowed to activate the BDT session for the UE or not.

In some embodiments, the first message may be a response message corresponding to the fourth message.

In some embodiments, the first message may be another message that is transmitted separately from the response message corresponding to the fourth message.

In some embodiments, the step S1110 of determining whether the UE infringes any of the one or more conditions may include determining whether the total data volume is consumed or not. In some embodiments, the step S1110 of determining whether the UE infringes any of the one or more conditions may further include determining that the UE infringes the at least one condition in response to determining that the total data volume is consumed.

In some embodiments, before the step of determining whether the total data volume is consumed or not, the method 1100 may include receiving, from the second network node, a fourth message for activating a BDT session for the UE. In some embodiments, before the step of determining whether the total data volume is consumed or not, the method 1100 may include determining a current available data volume associated with the BDT policy that is indicated by a reference ID comprised in the fourth message. In some embodiments, the current available data volume may have an initial value equal to the total data volume, and its value may be reduced whenever a volume slice is allocated for a BDT session for a UE associated with the BDT policy.

In some embodiments, the step of determining whether the total data volume is consumed or not may include determining that the total data volume is consumed in response to determining that the current available data volume is not greater than zero. In some embodiments, the step of determining whether the total data volume is consumed or not may further include determining that the total data volume is not consumed in response to determining that the current available data volume is greater than zero.

In some embodiments, the method 1100 may further include deducting, from the current available data volume, a volume of a volume slice that is allocated to the BDT session in response to determining that the total data volume is not consumed. In some embodiments, the method 1100 may further include determining an IP address of the UE from the fourth message. In some embodiments, the method 1100 may further include determining an identifier of the UE based on its IP address by looking up the IP address in a table that maps the IP address to the identifier, the table being maintained at the first network node. In some embodiments, the method 1100 may further include transmitting, to the third network node, a second subscription request for subscribing notification of an event that the volume slice is consumed by the BDT session.

In some embodiments, the method 1100 may further include receiving, from the third network node, a fifth message for notifying the event that the volume slice allocated to the BDT session is consumed. In some embodiments, the method 1100 may further include determining whether the current available data volume is greater than zero or not. In some embodiments, the method 1100 may further include deducting, from the current available data volume, a volume of another volume slice that is allocated to the BDT session in response to determining that the current available data volume is greater than zero. In some embodiments, the method 1100 may further include transmitting, to the third network node, another second subscription request for subscribing notification of an event that the other volume slice is consumed by the BDT session.

In some embodiments, the method 1100 may further include receiving, from the third network node, a fifth message for notifying the event that the volume slice allocated to the BDT session is consumed. In some embodiments, the method 1100 may further include determining whether the current available data volume is greater than zero or not. In some embodiments, the method 1100 may further include determining that the total data volume is consumed in response to determining that the current available data volume is not greater than zero.

In some embodiments, the method 1100 may further include transmitting, to the second network node, the first message for notifying that the at least one condition is infringed by the UE when the at least one condition includes the total data volume. In some embodiments, the method 1100 may further include determining all BDT sessions associated with the BDT policy in response to determining that the total data volume is consumed. In some embodiments, the method 1100 may further include, for each of the BDT sessions, transmitting, to the third network node, the second message indicating the infringement of the at least one condition to trigger updating of a charging rate applied for the corresponding BDT session.

In some embodiments, before the step S1110 of determining whether a UE infringes any of the one or more conditions, the method 1100 may further include receiving, from the second network node, a sixth message indicating that a notification of infringement of the BDT policy is enabled. In some embodiments, before the step S1110 of determining whether a UE infringes any of the one or more conditions, the method 1100 may further include creating a BDT session object for the BDT policy. In some embodiments, the BDT session object may include at least one of: a reference ID identifying the BDT policy; information of the BDT policy; a list of UEs that participate in data transfer associated with the BDT policy; and a current available data volume associated with the BDT policy.

In some embodiments, the first network node may be a Service Capability Exposure Function (SCEF) or a Network Exposure Function (NEF). In some embodiments, the second network node may be an Application Server (AS), a Service Capability Server (SCS), or an Application Function (AF). In some embodiments, the third network node may be a Policy and Charging Rule Function (PCRF) or a Policy Control Function (PCF).

FIG. 12 is a flow chart of an exemplary method 1200 at a first network node for handling infringement of one or more conditions associated with a negotiated BDT policy according to another embodiment of the present disclosure. The method 1200 may be performed at the first network node (e.g., SCEF/NEF 145 in FIGS. 5-10B). The method 1200 may comprise step S1210 and S1220. However, the present disclosure is not limited thereto. In some other embodiments, the method 1200 may comprise more steps, less steps, different steps, or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin at step S1210 where whether a UE infringes any of the one or more conditions other than one or more negotiated time intervals during which BDT is expected to be performed by the UE is determined.

In some embodiments, the method 1200 may further comprise a step S1220 where in response to determining that the UE infringes at least one of the one or more conditions, a first message for notifying that the at least one condition is infringed is transmitted to a second network node.

In some embodiments, the one or more conditions may include at least one of: a negotiated number of UEs expected to participate in data transfer associated with the BDT policy; a negotiated geographic area in which data transfer associated with the BDT policy is expected to be conducted; and a total data volume associated with the BDT policy.

In some embodiments, the method 1200 may further include triggering updating of a charging rate applied for the UE in response to determining that the UE infringes the at least one condition.

In some embodiments, the step of triggering updating of the charging rate applied for the UE in response to determining that the UE infringes the at least one condition may include triggering applying a charging rate for the UE that is different from a negotiated charging rate associated with the BDT policy in response to determining that the UE infringes the at least one condition.

In some embodiments, the step of triggering updating of a charging rate applied for the UE may include transmitting, to a third network node, a second message indicating the infringement of the at least one condition by the UE when the at least one condition includes the negotiated number of UEs and/or the total data volume.

In some embodiments, the step S1210 of determining whether the UE infringes any of the one or more conditions may include determining whether an index of the UE in a UE list is greater than the negotiated number of UEs or not, the UE list comprising all UEs that participate in BDT sessions and the UEs in the UE list being indexed in a chronological order of their corresponding BDT sessions. In some embodiments, the step S1210 of determining whether the UE infringes any of the one or more conditions may further include determining that the UE infringes the at least one condition in response to determining that the index of the UE in the UE list is greater than the negotiated number of UEs.

In some embodiments, before the step S1210 of determining whether the UE infringes any of the one or more conditions, the method 1200 may further include receiving, from the second network node, a fourth message for activating a BDT session for the UE. In some embodiments, before the step S1210 of determining whether the UE infringes any of the one or more conditions, the method 1200 may further include determining an identifier of the UE from the fourth message. In some embodiments, before the step S1210 of determining whether the UE infringes any of the one or more conditions, the method 1200 may further include adding the identifier of the UE into the UE list in response to determining that the UE is not in the UE list at least partially based on the identifier of the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the fourth message may include a reference ID identifying the BDT policy. In some embodiments, before the step of adding the identifier of the UE into the UE list, the method may further include retrieving the UE list by using the reference ID.

In some embodiments, after the step receiving, from the second network node, a fourth message for activating a BDT session for the UE, the method 1200 may include authenticating the fourth message to verify if the second network node is allowed to activate the BDT session for the UE or not.

In some embodiments, the first message may be a response message corresponding to the fourth message.

In some embodiments, the first message may be another message that is transmitted separately from the response message corresponding to the fourth message.

In some embodiments, the step S1210 of determining whether the UE infringes any of the one or more conditions may include receiving, from the third network node, a third message for notifying the first network node of an event that the UE exits from or enters into the negotiated geographic area. In some embodiments, the step S1210 of determining whether the UE infringes any of the one or more conditions may include determining that the UE infringes the at least one condition in response to the third message notifying an event that the UE exits from the negotiated geographic area.

In some embodiments, before the step of receiving, from the third network node, a third message, the method 1200 may further include receiving, from the second network node, a fourth message for activating a BDT session for the UE. In some embodiments, before the step of receiving, from the third network node, a third message, the method 1200 may further include determining an identifier of the UE from the fourth message. In some embodiments, before the step of receiving, from the third network node, a third message, the method 1200 may further include transmitting, to the third network node, a first subscription request for subscribing notification of the event for the UE.

In some embodiments, the fourth message may include an IP address of the UE. In some embodiments, the step of determining an identifier of the UE from the fourth message may include determining the identifier of the UE based on its IP address by looking up the IP address in a table that maps the IP address to the identifier, the table being maintained at the first network node.

In some embodiments, the first subscription request may include an indicator indicating the negotiated geographic area and the identifier of the UE.

In some embodiments, the first message may be another message that is transmitted separately from the response message corresponding to the fourth message.

In some embodiments, the step S1210 of determining whether the UE infringes any of the one or more conditions may include determining whether the total data volume is consumed or not. In some embodiments, the step S1210 of determining whether the UE infringes any of the one or more conditions may include determining that the UE infringes the at least one condition in response to determining that the total data volume is consumed.

In some embodiments, before the step of determining whether the total data volume is consumed or not, the method 1200 may include receiving, from the second network node, a fourth message for activating a BDT session for the UE. In some embodiments, before the step of determining whether the total data volume is consumed or not, the method 1200 may further include determining a current available data volume associated with the BDT policy that is indicated by a reference ID comprised in the fourth message. In some embodiments, the current available data volume may have an initial value equal to the total data volume, and its value may be reduced whenever a volume slice is allocated for a BDT session for a UE associated with the BDT policy.

In some embodiments, the step of determining whether the total data volume is consumed or not may include determining that the total data volume is consumed in response to determining that the current available data volume is not greater than zero. In some embodiments, the step of determining whether the total data volume is consumed or not may further include determining that the total data volume is not consumed in response to determining that the current available data volume is greater than zero.

In some embodiments, the method 1200 may further include deducting, from the current available data volume, a volume of a volume slice that is allocated to the BDT session in response to determining that the total data volume is not consumed. In some embodiments, the method 1200 may further include determining an IP address of the UE from the fourth message. In some embodiments, the method 1200 may further include determining an identifier of the UE based on its IP address by looking up the IP address in a table that maps the IP address to the identifier, the table being maintained at the first network node. In some embodiments, the method 1200 may further include transmitting, to the third network node, a second subscription request for subscribing notification of an event that the volume slice is consumed by the BDT session.

In some embodiments, the method 1200 may further include receiving, from the third network node, a fifth message for notifying the event that the volume slice allocated to the BDT session is consumed. In some embodiments, the method 1200 may further include determining whether the current available data volume is greater than zero or not. In some embodiments, the method 1200 may further include deducting, from the current available data volume, a volume of another volume slice that is allocated to the BDT session in response to determining that the current available data volume is greater than zero. In some embodiments, the method 1200 may further include transmitting, to the third network node, another second subscription request for subscribing notification of an event that the other volume slice is consumed by the BDT session.

In some embodiments, the method 1200 may further include receiving, from the third network node, a fifth message for notifying the event that the volume slice allocated to the BDT session is consumed. In some embodiments, the method 1200 may further include determining whether the current available data volume is greater than zero or not. In some embodiments, the method 1200 may further include determining that the total data volume is consumed in response to determining that the current available data volume is not greater than zero.

In some embodiments, the method 1200 may further include transmitting, to the second network node, the first message for notifying that the at least one condition is infringed by the UE when the at least one condition includes the total data volume. In some embodiments, the method 1200 may further include determining all BDT sessions associated with the BDT policy in response to determining that the total data volume is consumed. In some embodiments, the method 1200 may further include, for each of the BDT sessions, transmitting, to the third network node, the second message indicating the infringement of the at least one condition to trigger updating of a charging rate applied for the corresponding BDT session.

In some embodiments, before the step S1210 of determining whether a UE infringes any of the one or more conditions, the method 1200 may further include receiving, from the second network node, a sixth message indicating that a notification of infringement of the BDT policy is enabled. In some embodiments, before the step S1210 of determining whether a UE infringes any of the one or more conditions, the method 1200 may further include creating a BDT session object for the BDT policy. In some embodiments, the BDT session may include at least one of: a reference ID identifying the BDT policy; information of the BDT policy; a list of UEs that participate in data transfer associated with the BDT policy; and a current available data volume associated with the BDT policy.

In some embodiments, the first network node may be a SCEF or a NEF. In some embodiments, the second network node may be an AS, a SCS, or an AF. In some embodiments, the third network node may be a PCRF or a PCF.

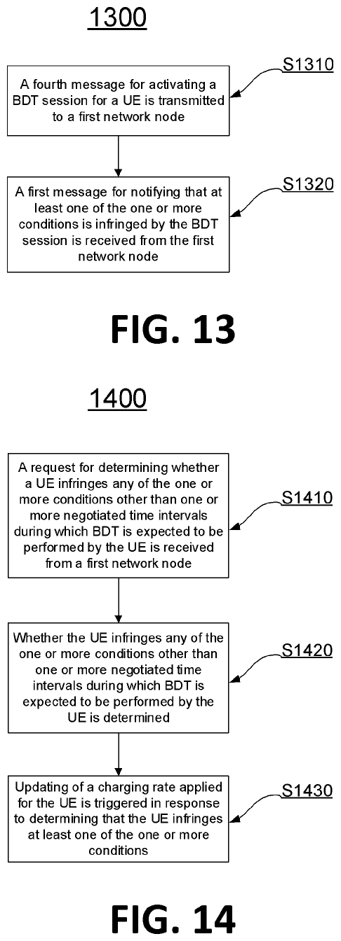

FIG. 13 is a flow chart of an exemplary method 1300 at a second network node handling infringement of one or more conditions associated with a negotiated BDT policy according to an embodiment of the present disclosure. The method 1300 may be performed at the second network node (e.g., AS/SCS/AF 125 in FIGS. 5-10B). The method 1300 may comprise step S1310 and S1320. However, the present disclosure is not limited thereto. In some other embodiments, the method 1300 may comprise more steps, less steps, different steps, or any combination thereof. Further the steps of the method 1300 may be performed in a different order than that described herein. Further, in some embodiments, a step in the method 1300 may be split into multiple sub-steps and performed by different entities, and/or multiple steps in the method 1300 may be combined into a single step.

The method 1300 may begin at step S1310 where a fourth message for activating a BDT session for a UE may be transmitted to a first network node.

In some embodiments, the method 1300 may further comprise a step S1320 where a first message for notifying that at least one of the one or more conditions is infringed by the BDT session is received from the first network node.

In some embodiments, the method 1300 may further include transmitting, to the first network node, a sixth message indicating that a notification of infringement of the BDT policy is enabled.

In some embodiments, the one or more conditions may include at least one of: a negotiated number of UEs expected to participate in data transfer associated with the BDT policy; a negotiated geographic area in which data transfer associated with the BDT policy is expected to be conducted; and a total data volume that is associated with the BDT policy.

In some embodiments, the fourth message may include an IP address of the UE.

In some embodiments, the fourth message may include a reference ID identifying the BDT policy.

In some embodiments, the first message may be a response message corresponding to the fourth message.

In some embodiments, the first message may be another message that is transmitted separately from the response message corresponding to the fourth message.

In some embodiments, the first network node may be a SCEF or a NEF. In some embodiments, the second network node may be an AS, a SCS, or an AF.

FIG. 14 is a flow chart of an exemplary method 1400 at a third network node handling infringement of one or more conditions associated with a negotiated BDT policy according to an embodiment of the present disclosure. The method 1400 may be performed at the third network node (e.g., the PCRF/PCF 120 in FIGS. 5-10B). The method 1400 may comprise step S1410, S1420, and S1430. However, the present disclosure is not limited thereto. In some other embodiments, the method 1400 may comprise more steps, less steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin at step S1410 where a request for determining whether a UE infringes any of the one or more conditions other than one or more negotiated time intervals during which BDT is expected to be performed by the UE is received from a first network node.

In some embodiments, the method 1400 may further comprise a step S1420 where whether the UE infringes any of the one or more conditions other than one or more negotiated time intervals during which BDT is expected to be performed by the UE is determined.

In some embodiments, the method 1400 may further comprise a step S1430 where updating of a charging rate applied for the UE is triggered in response to determining that the UE infringes at least one of the one or more conditions.

In some embodiments, the one or more conditions may include a negotiated geographic area in which data transfer associated with the BDT policy is expected to be conducted.

In some embodiments, the method 1400 may further include transmitting, to the first network node, a message for notifying an event that the UE exits from or enters into the negotiated geographic area in response to detecting the event.

In some embodiments, when the request is a subscription request for subscribing notification of the event that the UE exits from or enters into the negotiated geographic area, the subscription request may include an indicator indicating the negotiated geographic area and the identifier of the UE.

In some embodiments, the step of detecting the event may include performing a procedure for locating the UE indicated by the identifier of the UE. In some embodiments, the step of detecting the event may further include checking whether the UE exits from or enters into the negotiated geographic area by comparing the location of the UE with the negotiated geographic area.

In some embodiments, the first network node may be a SCEF or a NEF. In some embodiments, the third network node may be a PCRF or a PCF.

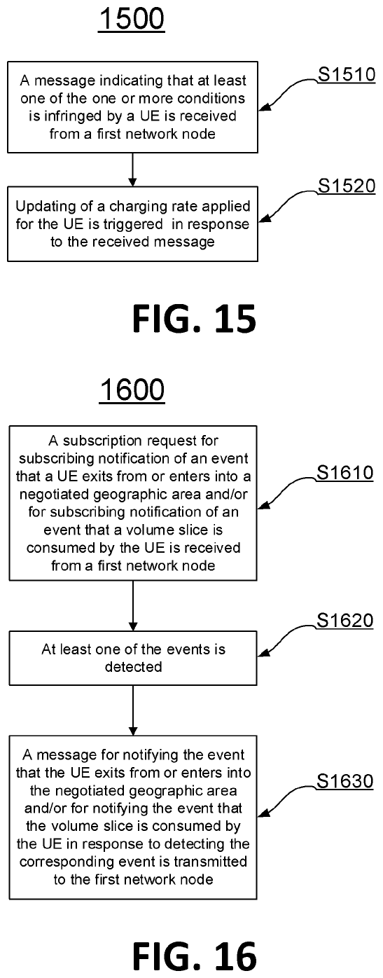

FIG. 15 is a flow chart of an exemplary method 1500 at a third network node handling infringement of one or more conditions associated with a negotiated BDT policy according to another embodiment of the present disclosure. The method 1500 may be performed at the third network node (e.g., the PCRF/PCF 120 in FIGS. 5-10B). The method 1500 may comprise step S1510 and S1520. However, the present disclosure is not limited thereto. In some other embodiments, the method 1500 may comprise more steps, less steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin at step S1510 where a message indicating that at least one of the one or more conditions is infringed by a UE is received from a first network node.

In some embodiments, the method 1500 may further comprise a step S1520 where updating of a charging rate applied for the UE may be triggered in response to the received message.

In some embodiments, the one or more conditions may include at least one of: a negotiated number of UEs expected to participate in data transfer associated with the BDT policy; and a total data volume associated with the BDT policy.

In some embodiments, the step S1520 of triggering updating of a charging rate applied for the UE in response to the received message may include triggering applying a charging rate for the UE that is different from a negotiated charging rate associated with the BDT policy in response to the received message.

In some embodiments, the first network node may be a SCEF or a NEF. In some embodiments, the third network node may be a PCRF or a PCF.

FIG. 16 is a flow chart of an exemplary method 1600 at a third network node handling infringement of one or more conditions associated with a negotiated BDT policy according to yet another embodiment of the present disclosure. The method 1600 may be performed at the third network node (e.g., the PCRF/PCF 120 in FIGS. 5-10B). The method 1600 may comprise step S1610, S1620, and S1630. However, the present disclosure is not limited thereto. In some other embodiments, the method 1600 may comprise more steps, less steps, different steps, or any combination thereof. Further the steps of the method 1600 may be performed in a different order than that described herein. Further, in some embodiments, a step in the method 1600 may be split into multiple sub-steps and performed by different entities, and/or multiple steps in the method 1600 may be combined into a single step.

The method 1600 may begin at step S1610 where a subscription request for subscribing notification of an event that a UE exits from or enters into a negotiated geographic area and/or for subscribing notification of an event that a volume slice is consumed by the UE is received from a first network node.

In some embodiments, the method 1600 may further comprise a step S1620 where at least one of the events is detected.

In some embodiments, the method 1600 may further comprise a step S1630 where a message for notifying the event that the UE exits from or enters into the negotiated geographic area and/or for notifying the event that the volume slice is consumed by the UE in response to detecting the corresponding event is transmitted to the first network node.

In some embodiments, when the subscription request is subscribing notification of the event that the UE exits from or enters into the negotiated geographic area, the subscription request may include an indicator indicating the negotiated geographic area and the identifier of the UE.

In some embodiments, the step S1620 of detecting at least one of the events may include performing a procedure for locating the UE indicated by the identifier of the UE. In some embodiments, the step S1620 of detecting at least one of the events may further include checking whether the UE exits from or enters into the negotiated geographic area by comparing the location of the UE with the negotiated geographic area.

In some embodiments, when the subscription request is subscribing notification of the event that the volume slice is consumed by the UE, the method 1600 may further include transmitting, to a fourth network node, a seventh message for subscribing an event that the volume slice is consumed by the UE.

In some embodiments, the method 1600 may further include receiving, from the fourth network node, an eighth message for notifying the event.

In some embodiments, the first network node may be a SCEF or a NEF. In some embodiments, the third network node may be a PCRF or a PCF. In some embodiments, the fourth network node may be a PCEF or a UPF.

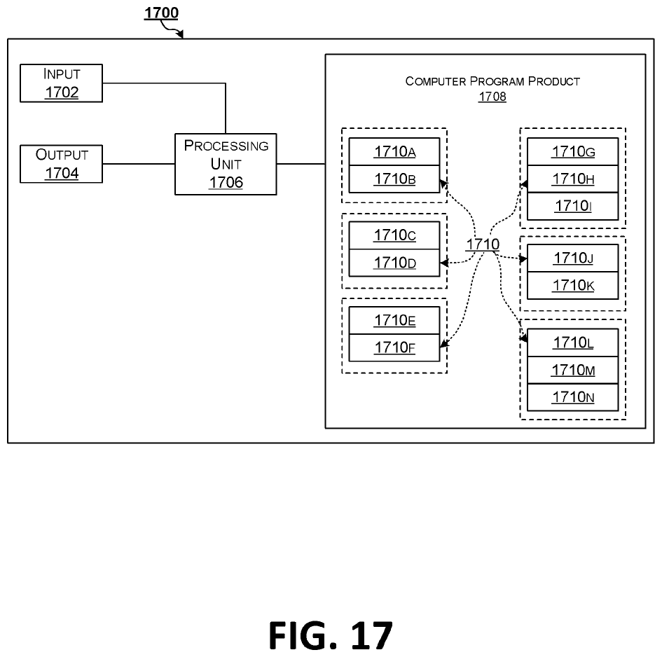

FIG. 17 schematically shows an embodiment of an arrangement 1700 which may be used in a first (e.g., the SCEF/NEF 145 in FIGS. 5-10B), second (e.g., the AS/SCS/AF 125 in FIGS. 5-10B), and/or third network node (e.g., the PCRF/PCF 120 in FIGS. 5-10B) according to an embodiment of the present disclosure. Comprised in the arrangement 1700 are a processing unit 1706, e.g., with a Digital Signal Processor (DSP) or a Central Processing Unit (CPU). The processing unit 1706 may be a single unit or a plurality of units to perform different actions of procedures described herein. The arrangement 1700 may also comprise an input unit 1702 for receiving signals from other entities, and an output unit 1704 for providing signal(s) to other entities. The input unit 1702 and the output unit 1704 may be arranged as an integrated entity or as separate entities.

Furthermore, the arrangement 1700 may comprise at least one computer program product 1708 in the form of a non-volatile or volatile memory, e.g., an Electrically Erasable Programmable Read-Only Memory (EEPROM), a flash memory and/or a hard drive. The computer program product 1708 comprises a computer program 1710, which comprises code/computer readable instructions, which when executed by the processing unit 1706 in the arrangement 1700 causes the arrangement 1700 and/or the first, second and/or third network nodes in which it is comprised to perform the actions, e.g., of the procedure described earlier in conjunction with FIGS. 5-16 or any other variant.

The computer program 1710 may be configured as a computer program code structured in computer program modules 1710A-1710D. Hence, in an exemplifying embodiment when the arrangement 1700 is used in a first network node, the code in the computer program of the arrangement 1700 includes a module 1710A for determining whether a UE infringes any of the one or more conditions other than one or more negotiated time intervals during which BDT is expected to be performed by the UE. Further, the code in the computer program of the arrangement 1700 further includes a module 1710B for triggering updating of a charging rate applied for the UE in response to determining that the UE infringes at least one of the one or more conditions.

In another exemplifying embodiment when the arrangement 1700 is used in a first network node, the code in the computer program of the arrangement 1700 includes a module 1710C for determining whether a UE infringes any of the one or more conditions other than one or more negotiated time intervals during which BDT is expected to be performed by the UE. Further, the code in the computer program of the arrangement 1700 further includes a module 1710D for in response to determining that the UE infringes at least one of the one or more conditions, transmitting, to a second network node, a first message for notifying that the at least one condition is infringed.

The computer program 1710 may be further configured as a computer program code structured in computer program modules 1710E-1710F. Hence, in an exemplifying embodiment when the arrangement 1700 is used in a second network node, the code in the computer program of the arrangement 1700 includes a module 1710E for transmitting, to a first network node, a fourth message for activating a BDT session for a UE. Further, the code in the computer program of the arrangement 1700 further includes a module 1710F for receiving, from the first network node, a first message for notifying that at least one of the one or more conditions is infringed by the BDT session.

The computer program 1710 may be further configured as a computer program code structured in computer program modules 1710G-1710N. Hence, in an exemplifying embodiment when the arrangement 1700 is used in a third network node, the code in the computer program of the arrangement 1700 includes a module 1710G for receiving, from a first network node, a request for determining whether a user equipment (UE) infringes any of the one or more conditions other than one or more negotiated time intervals during which BDT is expected to be performed by the UE. Further, the code in the computer program of the arrangement 1700 further includes a module 1710H for determining whether the UE infringes any of the one or more conditions other than one or more negotiated time intervals during which BDT is expected to be performed by the UE. Further, the code in the computer program of the arrangement 1700 further includes a module 1710I for triggering updating of a charging rate applied for the UE in response to determining that the UE infringes at least one of the one or more conditions.

In another exemplifying embodiment when the arrangement 1700 is used in a third network node, the code in the computer program of the arrangement 1700 includes a module 1710J for receiving, from a first network node, a message indicating that at least one of the one or more conditions is infringed by a UE. Further, the code in the computer program of the arrangement 1700 further includes a module 1710K for triggering updating of a charging rate applied for the UE in response to the received message.

In yet another exemplifying embodiment when the arrangement 1700 is used in a third network node, the code in the computer program of the arrangement 1700 includes a module 1710L for receiving, from a first network node, a subscription request for subscribing notification of an event that a UE exits from or enters into a negotiated geographic area and/or for subscribing notification of an event that a volume slice is consumed by the UE. Further, the code in the computer program of the arrangement 1700 further includes a module 1710M for detecting at least one of the events. Further, the code in the computer program of the arrangement 1700 further includes a module 1710N for transmitting, to the first network node, a message for notifying the event that the UE exits from or enters into the negotiated geographic area and/or for notifying the event that the volume slice is consumed by the UE in response to detecting the corresponding event.

The computer program modules could essentially perform the actions of the flow illustrated in FIGS. 5-16, to emulate the first, second, and/or third network nodes. In other words, when the different computer program modules are executed in the processing unit 1706, they may correspond to different modules in the first, second, and/or third network nodes.

Although the code means in the embodiments disclosed above in conjunction with FIG. 17 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU, but could also comprise two or more processing units. For example, the processor may include general purpose microprocessors, instruction set processors and/or related chips sets and/or special purpose microprocessors such as ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network nodes.

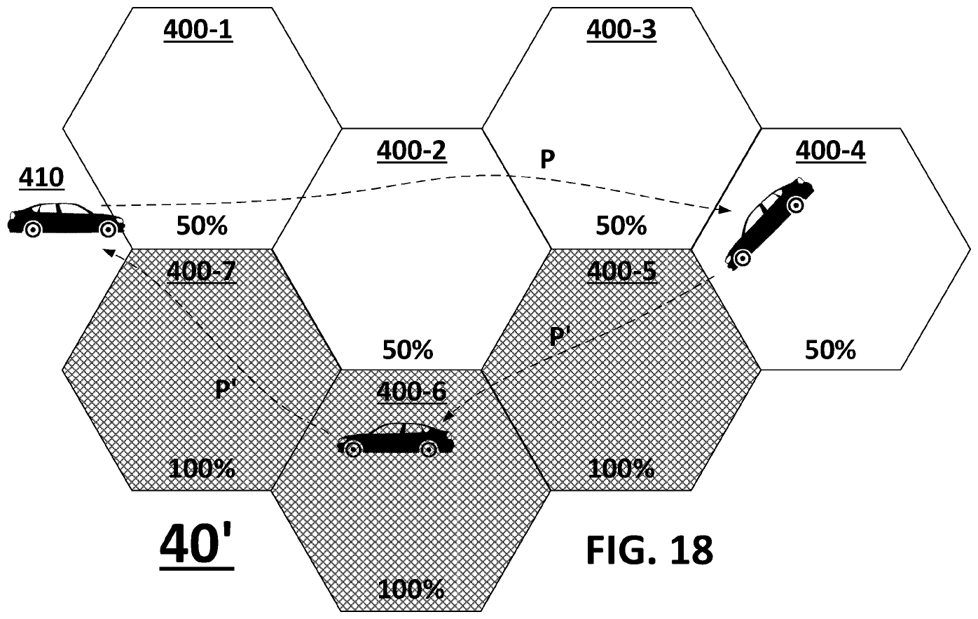

FIG. 18 is a diagram illustrating an exemplary scenario 40′ in which infringement of one or more conditions associated with a negotiated BDT policy is handled according to an embodiment of the present disclosure. The scenario 40′ is somehow similar to the scenario 40 shown in FIG. 4 with the exception that the infringement of one or more conditions may be handled properly in FIG. 18.

As shown in FIG. 18, the UE 410 may be communicatively connected to the AS/SCS/AF (e.g., the AS/SCS/AF 125), and may perform BDT based on a BDT policy negotiated between the AS/SCS/AF 125 and the SCEF/NEF 145 through the BDT policy negotiation procedure according to an embodiment of the present disclosure as shown in FIG. 5 and activated through the BDT policy activation procedure shown in any of FIGS. 7 to 10B.

As shown in FIG. 18, the UE 410 moves along a path P, and during the process it goes through cells 400-1, 400-2, 400-3, and 400-4. In the embodiment shown in FIG. 18, all four cells 400-1, 400-2, 400-3, and 400-4 are covered by the area associated with the negotiated BDT policy, and therefore the UE may satisfy all the conditions associated with the negotiated and activated BDT policy when moving in these cells, thus a reduced charging rate associated with the BDT policy (e.g., 50% of a normal charging rate) may be applied to the UE 410 when it goes through the cells 400-1, 400-2, 400-3, and 400-4 along the path P.

Later, the UE 410 returns to its original location along another path P′, and during this process it goes through cells 400-5, 400-6, and 400-7. During this process, however, one or more conditions associated with the negotiated BDT policy are infringed. As an example, the UE 410 may exit from the negotiated geographic area when passing through the cells 400-5, 400-6, and 400-7. As another example, when the UE 410 goes through the cells 400-5, 400-6, and 400-7, the negotiated total data volume has been consumed. As yet another example, when another UE goes through the cells 400-5, 400-6, and 400-7, the negotiated number of UEs has been exceeded. With the mechanisms provided in the present disclosure, infringement of the conditions associated with the negotiated BDT policy can be detected, corresponding updating of the charging rate applied to the UE can be trigged and realized. As a result, for example, an updated charging rate (e.g., 100% of the normal charging rate) may be applied to the UE 410 when it goes through the cells 400-5, 400-6 and 400-7.

In summary, a mechanism to handle infringement of one or more conditions associated with the negotiated BDT policy is provided in the present disclosure. In some embodiments, a mechanism is proposed in, for example, the PCRF/PCF 120, SCEF/NEF 145, and AS/SCS/AF 125, to monitor infringement of one or more conditions associated with the negotiated BDT by one or more UEs during the BDT, and once such infringement is detected, instead of a reduced charging rate, a normal charging rate is applied to these UEs. In some embodiments, this mechanism can also enable notification of the infringement event to other network nodes, such as the PCRF/PCF 120, SCEF/NEF 145, and/or AS/SCS/AF 125.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AS | Application Server |
| BDT | Background Data Transfer |
| MTC | Machine Type Communication |
| NEF | Network Exposure Function |
| PCF | Policy Control Function |
| PCRF | Policy and Charging Rule Function |
| SCEF | Service Capability Exposure Function |
| SCS | Service Capability Server |
| UE | User Equipment |

1. A method at a first network node for handling infringement of one or more conditions associated with a negotiated background data transfer (BDT) policy, the method comprising:
determining whether a user equipment (UE) infringes any of the one or more conditions other than one or more negotiated time intervals during which BDT is expected to be performed by the UE; and
triggering updating of a charging rate applied for the UE in response to determining that the UE infringes at least one of the one or more conditions.

2. The method of claim 1, wherein the step of triggering updating of the charging rate applied for the UE comprises:
triggering applying a charging rate for the UE that is different from a negotiated charging rate associated with the BDT policy in response to determining that the UE infringes the at least one condition.

3. The method of claim 1, wherein the one or more conditions comprise at least one of:
a negotiated number of UEs expected to participate in data transfer associated with the BDT policy; and
a total data volume associated with the BDT policy.

4. The method of claim 1, further comprising:
transmitting, to a second network node, a first message for notifying that the at least one condition is infringed in response to determining that the UE infringes the at least one condition.

5. The method of claim 1, wherein the step of triggering updating of a charging rate applied for the UE comprises:
transmitting, to a third network node, a second message indicating the infringement of the at least one condition by the UE when the at least one condition comprises the negotiated number of UEs and/or the total data volume.

6. The method of claim 1, wherein the step of determining whether the UE infringes any of the one or more conditions comprises:
determining whether an index of the UE in a UE list is greater than the negotiated number of UEs or not, the UE list comprising all UEs that participate in BDT sessions and the UEs in the UE list being indexed in a chronological order of their corresponding BDT sessions; and
determining that the UE infringes the at least one condition in response to determining that the index of the UE in the UE list is greater than the negotiated number of UEs.

7. The method of claim 6, wherein before the step of determining whether the UE infringes any of the one or more conditions, the method further comprises:
receiving, from the second network node, a fourth message for activating a BDT session for the UE;
determining an identifier of the UE from the fourth message; and
adding the identifier of the UE into the UE list in response to determining that the UE is not in the UE list at least partially based on the identifier of the UE.

8. The method of claim 7, wherein the fourth message comprises an IP address of the UE,
wherein the step of determining an identifier of the UE from the fourth message comprises:
determining the identifier of the UE based on its IP address by looking up the IP address in a table that maps the IP address to the identifier, the table being maintained at the first network node.

9. The method of claim 7, wherein the fourth message comprises a reference ID identifying the BDT policy,
wherein before the step of adding the identifier of the UE into the UE list, the method further comprises:
retrieving the UE list by using the reference ID.

10-48. (canceled)

49. A method at a second network node for handling infringement of one or more conditions associated with a negotiated background data transfer (BDT) policy, the method comprising:
transmitting, to a first network node, a fourth message for activating a BDT session for a UE; and
receiving, from the first network node, a first message for notifying that at least one of the one or more conditions is infringed by the BDT session.

50. The method of claim 49, further comprising:
transmitting, to the first network node, a sixth message indicating that a notification of infringement of the BDT policy is enabled.

51. The method of claim 49, wherein the one or more conditions comprise at least one of:
a negotiated number of UEs expected to participate in data transfer associated with the BDT policy;
a negotiated geographic area in which data transfer associated with the BDT policy is expected to be conducted; and
a total data volume that is associated with the BDT policy.

52-63. (canceled)

64. A method at a third network node for handling infringement of one or more conditions associated with a negotiated background data transfer (BDT) policy, the method comprising:
receiving, from a first network node, a message indicating that at least one of the one or more conditions is infringed by a user equipment (UE); and
triggering updating of a charging rate applied for the UE in response to the received message.

65. The method of claim 64, wherein the one or more conditions comprise at least one of:
a negotiated number of UEs expected to participate in data transfer associated with the BDT policy; and
a total data volume associated with the BDT policy.

66. The method of claim 64, wherein the step of triggering updating of a charging rate applied for the UE in response to the received message comprises:
triggering applying a charging rate for the UE that is different from a negotiated charging rate associated with the BDT policy in response to the received message.

67-77. (canceled)
